(19) United States
(12) Patent Application Publication
(10) Pub. No.: US 2025/0054218 A1
(43) Pub. Date: Feb. 13, 2025

(54) VIRTUAL WINDOW APPARATUS AND SYSTEM

(71) Applicant: LiquidView, Corp, San Rafael, CA (US)

(72) Inventors: Mitchell Braff, San Rafael, CA (US); Jan C. Hobbel, San Rafael, CA (US); Paulina A. Perrault, San Rafael, CA (US); Adam Sah, San Rafael, CA (US); Kangil Cheon, San Francisco, CA (US); Yeongkeun Jeong, San Francisco, CA (US); Grishma Rao, San Francisco, CA (US); Noah Michael Shibley, San Francisco, CA (US); Hyerim Shin, San Francisco, CA (US); Marcelle van Beusekom, San Francisco, CA (US); William D. Hofmann, Berkeley, CA (US)

(21) Appl. No.: 18/930,796

(22) Filed: Oct. 29, 2024

Related U.S. Application Data
(63) Continuation-in-part of application No. 18/434,646, filed on Feb. 6, 2024.
Application No. 18/434,646 is a continuation of application No. 17/404,917, filed on Aug. 17, 2021, now Pat. No. 11,900,521.
(60) Provisional application No. 63/066,675, filed on Aug. 17, 2020.
(60) Provisional application No. 63/209,510, filed on Jun. 11, 2021.

(51) Int. Cl. G06T 13/60; G06F 3/147; G09G 5/00; H04N 7/18

(52) U.S. Cl. CPC G06T 13/60; G06F 3/147; G09G 5/003; H04N 7/183; G09G 2380/16

(57) ABSTRACT

A virtual window is located at a first location and includes an electronic display configured to be mounted on or embedded in a surface of a building and a layer of tempered glass spaced from the electronic display. The glass protects the electronic display and provides reflections of light visible to a user. A computer system is communicably coupled to the electronic display and configured to store a view of a second location downloaded from a computer server, wherein the video is manipulated based on sunrise and sunset times at the first location. Downloading of the view from the computer server to the virtual window is controllable by a software application running on a user device operable by the user.

### CROSS-REFERENCE TO RELATED APPLICATIONS

This application is a continuation-in-part of U.S. patent application Ser. No. 18/434,646 (attorney docket no. 149765.8003.US02), filed Feb. 6, 2024, which is a continuation of U.S. patent application Ser. No. 17/404,917 (attorney docket no. 149765.8003.US01), filed Aug. 12, 2021, now U.S. Pat. No. 11,900,521, granted Feb. 13, 2024, which claims the benefit of U.S. Provisional Patent Application No. 63/066,675 (attorney docket no. 137730.8003.US00), filed Aug. 17, 2020 and U.S. Provisional Patent Application No. 63/209,510 (attorney docket no. 137730.8004.US00), filed Jun. 11, 2021, all of which are incorporated by reference in their entireties herein.

### TECHNICAL FIELD

This description relates generally to virtual window apparatuses and systems.

### BACKGROUND

Some indoor and even outdoor spaces have no source of natural light. That is, there may be no windows in such spaces, e.g., basements, conference rooms, partially enclosed patios, bathrooms, or business lobbies that have no access to windows. As such, these spaces can seem confining. Further, in some locations, even if there is natural light, a nice or pleasing view is not available, e.g., urban areas with high density or spaces next to buildings.

### SUMMARY

Apparatuses and systems for virtual windows are disclosed. A virtual window refers to a system including an electronic display, one or more computer processors, computer memory, and electronic circuitry disposed within a housing and configured to be mounted on or embedded within a surface of a building (e.g., a wall or ceiling of a house or a wall in a bar that is partially open to the environment). The virtual window displays video depicting a scene at a geographical location, images, text, graphics, and/or a computer application. The virtual window can provide a realistic impression of looking out of an actual window.

In some embodiments described herein, a computer system receives a first selection of a first view for displaying on a virtual window. The computer system can be a computer server external to the virtual window. The first selection is received from a user device that is remote to the computer system and proximate to the virtual window. The first selection is associated with a particular time and/or a geographical location. The computer system generates a quick-response (QR) code for displaying within the first view. The QR code can be colored to blend into a background of the first view. Colors of the QR code can change as the background of the first view changes. The QR code is configured to direct a browser of the user device to a web page or universal resource locator (URL) for viewing the web page or URL on the user device. The QR code is composited into the first view for displaying on the virtual window. The computer system receives a second selection of a second view for displaying on the virtual window. The second selection is received via the web page. In response to receiving the second selection, the second view is sent to the virtual window for displaying on the virtual window.

In some embodiments, a computer system receives a selection of a first view for displaying on a first virtual window at a location. The computer system generates a second view corresponding to the first view for displaying on a second virtual window at the location. The computer system sends the first view to the first virtual window for displaying on the first virtual window. The computer system detects an object (e.g., a bird, clouds, or raindrops) moving across the first view. The object has a first perspective corresponding to the first view. The computer system generates an image of the object for displaying in the second view, wherein the image has a second perspective corresponding to the second view. The computer system composites the image of the object in the second view for displaying on the second virtual window or sends the image of the object to the second virtual window for compositing. Display of motion of the object across the second view is timed relative to motion of the object across the first view.

In some embodiments, a computer system determines that a menu option in a software application of a virtual window system has been set to display an avatar of a user of the virtual window system within views displayed on a virtual window when the user is present at a particular location. As used herein, the term “virtual window system” can refer either to hardware and/or software running on a remote server that one or more virtual windows can connect to. The term “virtual window system” can also be used to describe a system including the hardware and/or software running on a server, the virtual windows, and one or more user devices that interact with the server and the virtual windows. The computer system can be a user device such as a smartphone. The software application is executed on the computer system. The computer system receives a selection of a view for displaying on the virtual window. The computer system determines that it is connected to a wireless network associated with the particular location. Responsive to determining that the computer system is connected to the wireless network, the virtual window system is caused to generate the avatar of the user for displaying within the view, wherein a display of the avatar changes as images in the view change. The avatar is sent to the virtual window for compositing into the view. The computer system causes the virtual window to download the avatar received from the virtual window system, composite the avatar with the view, and display the view on an electronic display of the virtual window.

These and other aspects, features, and implementations can be expressed as methods, apparatuses, systems, components, program products, means or steps for performing a function, and in other ways.

These and other aspects, features, and implementations will become apparent from the following descriptions, including the claims.

### BRIEF DESCRIPTION OF THE DRAWINGS

Detailed descriptions of implementations of the present technology will be described and explained through the use of the accompanying drawings.

FIG. 1 is a block diagram illustrating an example system for generating views for virtual windows, in accordance with one or more embodiments.

FIG. 2 illustrates an example view of an urban area displayed using a virtual window, in accordance with one or more embodiments.

FIG. 3 illustrates an example view of a suburban area displayed using a virtual window, in accordance with one or more embodiments.

FIG. 4 illustrates an example winter view displayed using a virtual window, in accordance with one or more embodiments.

FIG. 5 illustrates an example tropical view displayed using a virtual window, in accordance with one or more embodiments.

FIG. 6 illustrates an example view of a night sky, in accordance with one or more embodiments.

FIG. 7 is a screenshot of an example event displayed using a virtual window, in accordance with one or more embodiments.

FIG. 8 illustrates example images of two corner windows displayed on a virtual window, in accordance with one or more embodiments.

FIGS. 9A and 9B illustrate example views having objects in the foreground displayed using virtual windows, in accordance with one or more embodiments.

FIG. 10A illustrates an example view having an object in the foreground displayed using a virtual window, in accordance with one or more embodiments.

FIG. 10B illustrates an example view lacking an object in the foreground displayed using a virtual window, in accordance with one or more embodiments.

FIG. 11 illustrates an example unacceptable view having blurred leaves displayed in the foreground, in accordance with one or more embodiments.

FIG. 12 illustrates an example unacceptable view displayed using a virtual window, in accordance with one or more embodiments.

FIG. 13 is a screenshot of an example view from a virtual window where approximately half the frame shows the sky, in accordance with one or more embodiments.

FIG. 14A illustrates an example day view of a particular area displayed using a virtual window, in accordance with one or more embodiments.

FIG. 14B illustrates an example night view of the particular area displayed in FIG. 14A, in accordance with one or more embodiments.

FIG. 15 is a block diagram illustrating components of an example system for generating soundscapes, in accordance with one or more embodiments.

FIG. 16 illustrates an example configuration for virtual windows, in accordance with one or more embodiments.

FIG. 17 illustrates an example configuration for a virtual window, in accordance with one or more embodiments.

FIG. 18 illustrates an example configuration for a virtual window, in accordance with one or more embodiments.

FIG. 19 illustrates an example configuration for a virtual window, in accordance with one or more embodiments.

FIG. 20 illustrates an example configuration for a virtual window, in accordance with one or more embodiments.

FIG. 21 illustrates an example field of view for a virtual window, in accordance with one or more embodiments.

FIG. 22 illustrates an example environment for virtual windows, in accordance with one or more embodiments.

FIG. 23 illustrates an example process for operating a virtual window system, in accordance with one or more embodiments.

FIG. 24 illustrates an example process for operating a virtual window, in accordance with one or more embodiments.

FIG. 25 illustrates an extended-reality (XR) system, in accordance with one or more embodiments.

FIG. 26 is a block diagram illustrating an example artificial intelligence (AI) system, in accordance with one or more embodiments.

FIG. 27 is a block diagram illustrating an example computer system, in accordance with one or more embodiments.

FIG. 28 is a drawing illustrating an example user interface, in accordance with one or more embodiments.

FIGS. 29A and 29B are drawings illustrating example user devices, in accordance with one or more embodiments.

FIG. 30 is a drawing illustrating an exploded view of an example virtual window, in accordance with one or more embodiments.

FIG. 31 shows a panoramic view presented by three virtual windows, in accordance with one or more embodiments.

FIGS. 32A-32C show the generation of a three-screen panorama according to an embodiment in which FIG. 3A is a source view, FIG. 3B shows the source view sliced into three sections to create the illusion of reality, and FIG. 3C shows the completed three-screen panorama.

FIG. 33 shows an embodiment that provides a wall window design that hangs on the wall with a backplate to which a cleat mount is attached.

FIGS. 34A and 34B show an embodiment of an on-wall design (see FIG. 34A) in which the media player, power supplies, and plugs are placed in the windowsill (see FIG. 34B).

FIGS. 35A and 35B show an embodiment that displays views in a portrait orientation where the case of the virtual window is rotated 90°, after which the view changes its orientation from portrait to landscape.

The technologies described herein will become more apparent to those skilled in the art from studying the Detailed Description in conjunction with the drawings. Embodiments or implementations describing aspects of the technologies are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the following description, for the purposes of explanation, numerous specific details are set forth in order to provide a thorough understanding of the present embodiments. It will be apparent, however, that the present embodiments can be practiced without these specific details.

Embodiments of the present disclosure will be described more thoroughly from now on with reference to the accompanying drawings. Like numerals represent like elements throughout the several figures, and in which example embodiments are shown. However, embodiments of the claims can be embodied in many different forms and should not be construed as limited to the embodiments set forth herein. The examples set forth herein are non-limiting examples and are merely examples, among other possible examples. Throughout this specification, plural instances (e.g., “2505”) can implement components, operations, or structures (e.g., “2505a”) described as a single instance. Further, plural instances (e.g., “2505”) refer collectively to a set of components, operations, or structures (e.g., “2505a”) described as a single instance. The description of a single component (e.g., “2505a”) applies equally to a like-numbered component (e.g., “2505b”) unless indicated otherwise. These and other aspects, features, and implementations can be expressed as methods, apparatuses, systems, components, program products, means or steps for performing a function, and in other ways. These and other aspects, features, and implementations will become apparent from the following descriptions, including the claims.

This document presents systems and apparatuses to implement and control virtual windows. A video depicting a view of a first location is received from a camera or a computer device by a virtual window. In some implementations, an image of a virtual casing, a virtual frame, or (optionally) muntins or mullions can be composited into the video. The image can be composited with the video to provide an illusion of an actual window to a user viewing the video. The user and the virtual window are located at a second location. The video is displayed on an electronic display of the virtual window for viewing by the user. In some embodiments, the virtual window (including the electronic display) is configured to be either mounted on a wall, fully portable, attached to other objects, or itself part of another device. One or more processors can be electronically coupled to the electronic display and configured to receive a video from a server. A length-of-day at the location in the video is synchronized with a length-of-day at the viewing location.

In some embodiments, an assembly for a virtual window includes a casing configured to surround a virtual frame of the virtual window and be installed on a wall to seal a perimeter of the virtual window to the wall. One or more panes of glass or acrylic can be attached to the casing and spaced from the electronic display of the virtual window by a particular separation. The one or more panes are configured to permit a user located at a location to view the virtual window through the one or more panes. The one or more panes provide reflections of light to the user, providing a realistic impression of an actual window. One or more muntins or mullions can optionally be attached to the casing and configured to separate at least one pane of the one or more panes from at least another pane of the one or more panes. The muntins support the one or more panes at the particular separation from the virtual window.

One or more processors can be positioned and concealed by the casing or the electronic display. The processors can receive a video depicting a view of another location and generate a virtual frame. The generation includes providing reflections of at least a portion of the view on the frame. The processors can synchronize a time-of-view at the location in the video with a time-of-day at the viewing location. The processors can also synchronize a length-of-day at the location in the video with a length-of-day at the viewing location. An electronic display is communicatively coupled to the one or more processors and configured to be positioned and surrounded by the casing. The electronic display is further configured to display the video and the virtual frame to provide the virtual window for viewing by the user.

The advantages and benefits of the virtual window apparatuses and systems described herein include providing digital images and videos to simulate actual windows at a user's location. The embodiments provide pleasing views from other locations, such as, for example, tropical beaches. Using the systems disclosed, a sense of motion can also be provided using digital image relays and recordings. The virtual windows disclosed cause viewers to experience a sense of disbelief, e.g., to give the viewer the sense that they are looking through an actual window. Using the embodiments disclosed herein, different exterior locations can be realistically simulated to provide an illusion that a user is looking through an actual window at a physically different location from where they are currently situated. The virtual window can be positioned in a portrait or landscape configuration to fit visually best within the location in which it is placed. For example, in a location having vertical windows or other such features, the electronic display is positioned vertically in a portrait orientation to match the windows. In an environment having horizontal windows or other such features, the display is positioned horizontally in a landscape orientation, improving functionality and aesthetics.

Operation of the virtual windows and the virtual window systems as disclosed herein can cause a reduction in greenhouse gas emissions compared to traditional methods for data transfer. Every year, approximately 40 billion tons of CO2 are emitted around the world. Power consumption by digital technologies accounts for approximately 4% of this figure. Further, conventional methods for data transfer can exacerbate the causes of climate change. For example, in the U.S., datacenters are responsible for approximately 2% of the country's electricity use, while globally, they account for approximately 200 terawatt-hours (TWh). The average U.S. power plant expends approximately 600 grams of carbon dioxide for every kWh generated. Transferring 1 GB of data can produce approximately 3 kg of CO2. Each GB of data downloaded thus results in approximately 3 kg of CO2 emissions or other greenhouse gas emissions. The storage of 100 GB of data in the cloud every year produces approximately 0.2 tons of CO2 or other greenhouse gas emissions.

The implementations disclosed herein for operating the virtual windows and the virtual window systems can mitigate climate change by reducing and/or preventing additional greenhouse gas emissions into the atmosphere. For example, the storage and transfer of content for unexpected events or time synchronization as described herein reduce electrical power consumption and the amount of data transported and stored compared to traditional methods for data transfer. Significant increases in efficiency are achieved since the video clips generated are in a range from 4 to 20 seconds. Such files are more efficient to transmit to a virtual window because of their relatively smaller size. Using the disclosed methods, an entire view can be downloaded into a client virtual window system having onboard storage. The data transfer and storage methods disclosed herein reduce the amount of data transported and stored and obviate the need for wasteful CO2 emissions. Moreover, video codecs designed for higher resolution, lower framerate, and more efficient video event insertion are used. Therefore, the disclosed implementations mitigate climate change and the effects of climate change by reducing the amount of data stored and downloaded in comparison to conventional technologies.

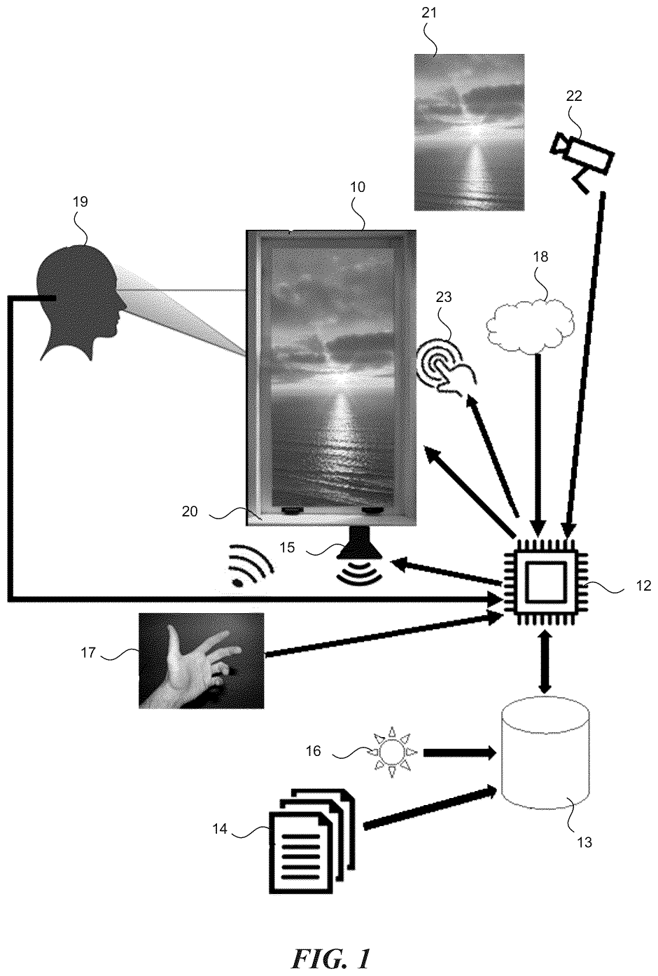

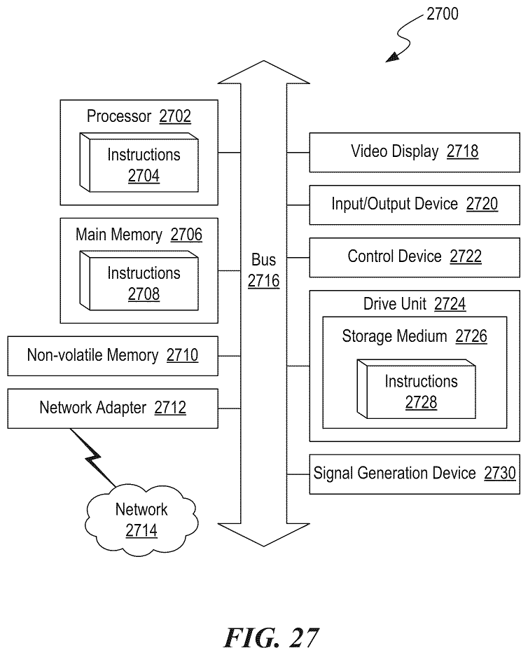

FIG. 1 is a block diagram illustrating a system for generating views for virtual windows, in accordance with one or more embodiments. A view refers to all the things that can be seen on the electronic display of a virtual window. The system illustrated in FIG. 1 is used to realistically simulate different exterior locations within an interior location. The system is implemented using components of the example computer system 2700 illustrated and described in more detail with reference to FIG. 27. Likewise, other embodiments include different and/or additional components or are connected in a different manner.

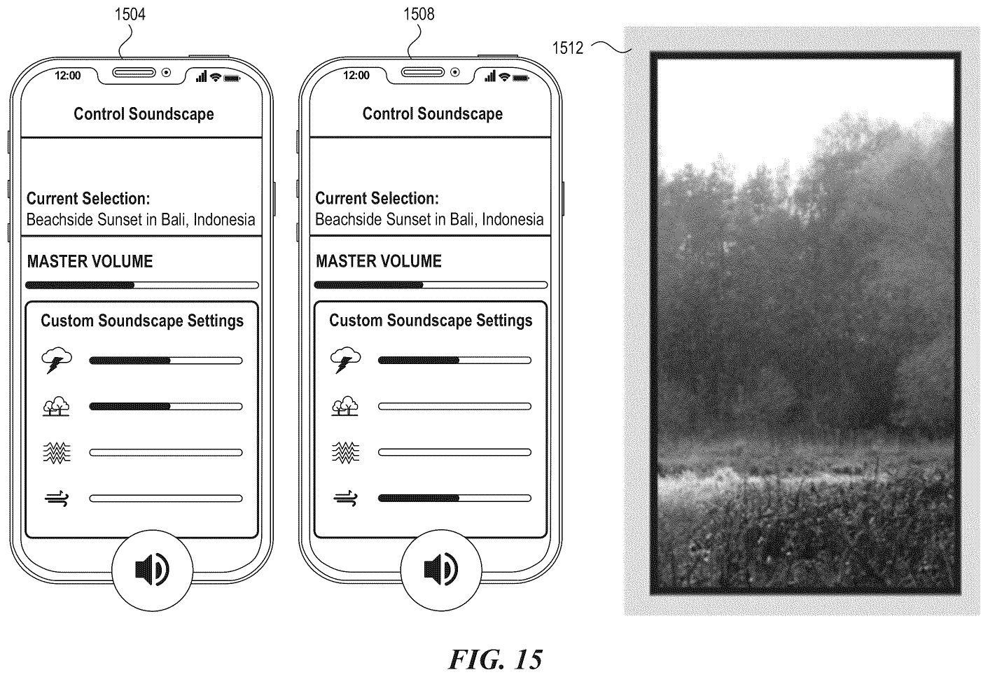

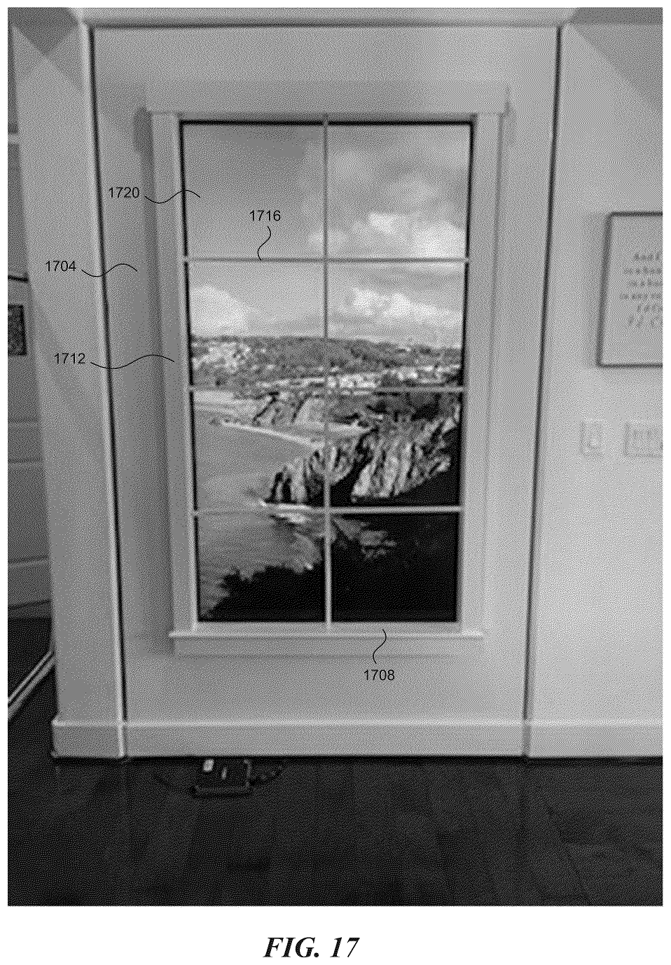

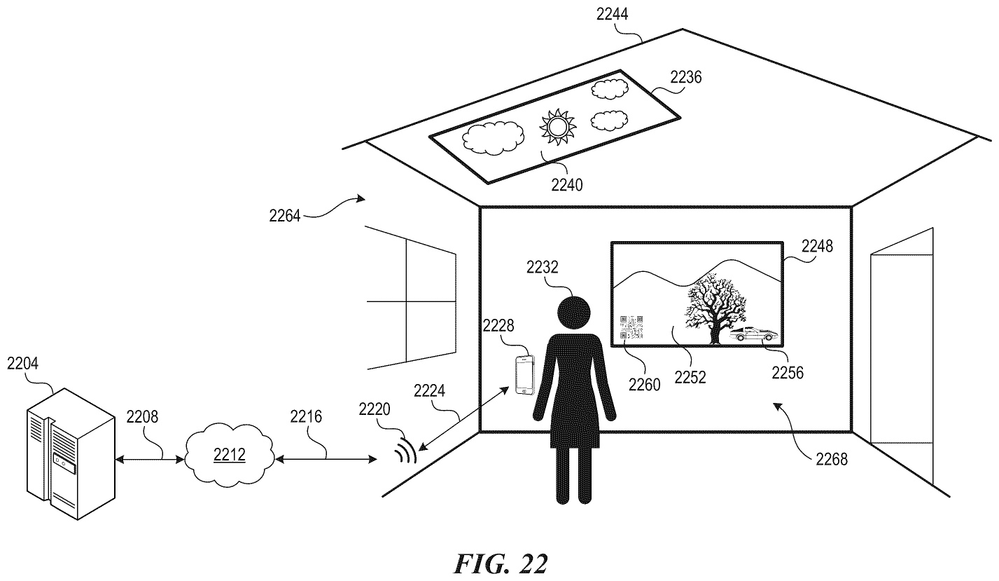

In some embodiments, one or more processors 12 receive a video depicting a view 21 of a geographical location. The processors 12 can be part of the electronic display 10, separate from and electronically coupled to the electronic display within the virtual window, or part of a remote server implemented using components of the example computer system 2700 illustrated and described in more detail with reference to FIG. 27. For example, electronic displays having faster processors do not need a separate processor to control video. The electronic display 10 shown in FIG. 1 is provided with video or image information, which can include a live video stream of the view 21, e.g., as streamed to one or more processors 12 from a camera 22, e.g., a webcam or other type of camera or a server (e.g., server 2204 shown by FIG. 22). The electronic display 10 is configured to provide an illusion to the user of viewing the geographical location through the virtual window. An example virtual window 1512 is illustrated and described in more detail with reference to FIG. 15. In some embodiments, the one or more processors 12 generate and composite an image of a virtual frame 20 with the video to provide an illusion of an actual framed window in the user's location to a user viewing the video. A virtual casing can also be generated surrounding the window. An example actual casing 1704 is illustrated and described in more detail with reference to FIG. 17.

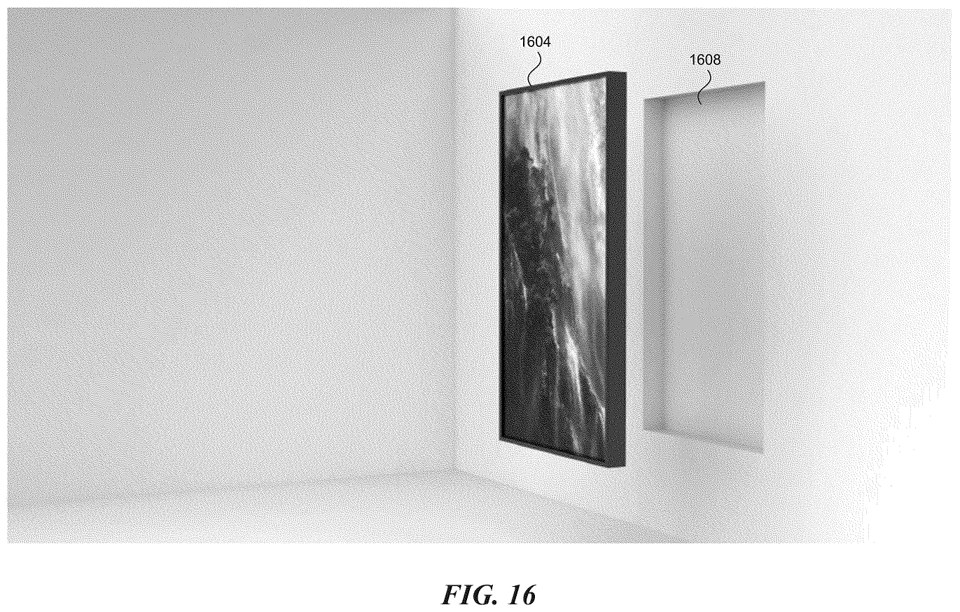

In other embodiments, the electronic display 10 is configured to be mounted on a wall in the user's location (e.g., the electronic display 1604 illustrated and described in more detail with reference to FIG. 16), embedded in a wall in the user's location, fully portable (carried by the user or a vehicle), attached to other objects, or itself part of another device in the user's location. The one or more processors 12 can be electronically coupled to the electronic display 10 and configured to receive the video from a server. The video depicts the view 21 of the geographical location and can include an image of a virtual casing, the virtual frame 20, or (optionally) one or more virtual muntins or mullions. The virtual casing surrounds the illusionary window. In some embodiments, the one or more processors 12 are further configured to generate an image of one or more panes of glass attached to the virtual casing or virtual frame 20. The one or more virtual panes can be separated by virtual muntins or mullions. The processors 12 composite the video with the image to provide reflections of light to the user, providing a realistic impression of an actual window reflecting light.

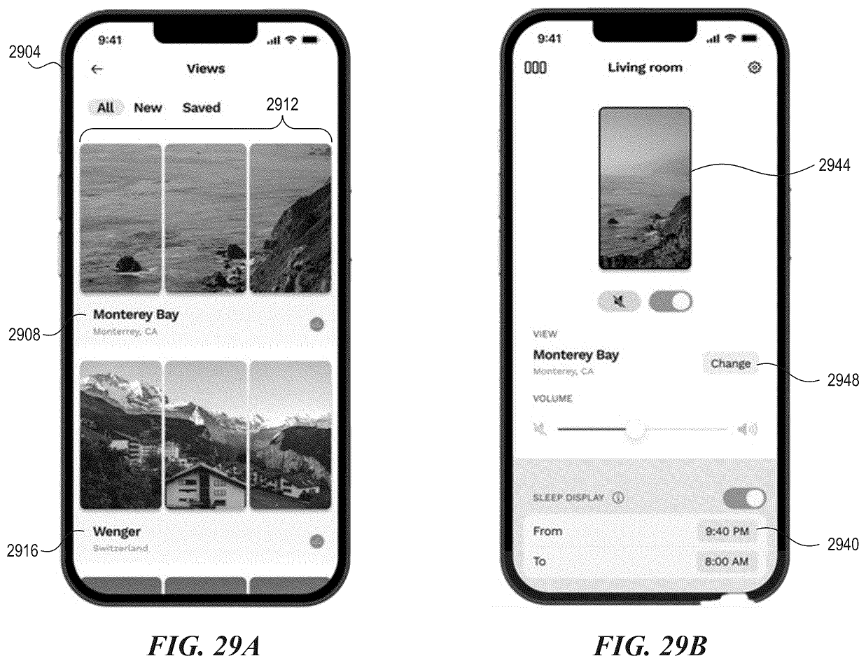

In some embodiments, the video or image information includes a library 14 of image or video information (e.g., library 2912 shown by FIG. 29) that is stored in a database 13 that is accessible by the processors 12. In some embodiments, streaming video is used. The video can be streamed from a remote server or locally, e.g., from storage that is proximate to the processors 12, such as detached storage, network attached storage (NAS), Internet service provider (ISP) caches, etc. The information is preferably video information, i.e., a view that is dynamically changing over time. In some embodiments, the processors 12 provide a backup image on the electronic display 10 responsive to detecting an interruption in transmitting a video to the electronic display 10. For example, a still image can be provided as a backup in the event the dynamic image is interrupted.

The processors 12 can provide localization and realism by, for example, tracking the local weather 18 and processing the video to reflect current weather conditions. For example, the view is of Hawaii and the virtual window's physical location is in New York, where it is currently snowing. The virtual window system can track live online weather data for New York and use an artificial intelligence algorithm to add digital snow to the view on the virtual window such that a user in New York will see snow in the view of Hawaii on the virtual window. In some embodiments, a virtual window system manipulates a length of a view (e.g., a 24-hour video) shot at a first location to match a sunrise and sunset time at a second location where the virtual window is used to display the view. Thus, the length-of-day appearing in the view can be shortened or lengthened depending on the quality of light at the second location (e.g., twilight, dusk, sunrise, high noon, or sunset). The view 21 can track local sunrise/sunset conditions 16 using a look-up table in the database 13. The processors 12 can adjust the duration of a pre-recorded view such that the display 10 shows a current accurate sunrise and sunset for local conditions. In an embodiment, a recording of a remote location is time-shifted, e.g., a view from Paris, France, can be time-shifted to show a Paris sunrise in Dallas, Texas, at the time the sun rises in Dallas.

In some embodiments, the one or more processors 12 track a perspective of the user relative to the electronic display 10. The processors 12 modify the video based on a change in the perspective. In some embodiments, the perspective is based on a distance of the user from the electronic display 10 and an angle at which the user is viewing the electronic display 10. Tracking the perspective includes eye tracking or facial tracking. For example, when a user's gaze within a room changes perspective, the view 21 of content on the electronic display 10 is changed to match the perspective of the user relative to the screen, i.e., the user's parallax. A camera on or around the display 10 tracks the user's angle and distance from the display 10, e.g., via eye tracking and/or facial tracking. An algorithm is run to change the video currently being displayed. The eye tracking mechanism 19 tracks the eye movement and/or facial movement of a user as the user gazes through the virtual window provided by the display 10. Responsive thereto, the processors 12 alter the perspective of the video on the display 10 such that the video appears as would be expected as the user gazes at a real view. Such modification occurs in real time on the processors 12, although in some embodiments, such as using 5G, the response time is near enough to real time to suffice.

In some embodiments, the one or more processors 12 store the video on a memory (e.g., a memory stick, a RAM, a hard drive, etc.) of the electronic display 10. The memory can be implemented using the components illustrated and described in more detail with reference to FIG. 27. The one or more processors 12 can be located within the electronic display 10 or the virtual window. In other embodiments, the one or more processors 12 are located remotely to the electronic display 10. For example, the image information can be of the user's location, e.g., a view that one would expect if the display 10 were an actual window at the user's location, or the image information can include a view from any other location, e.g., the user can access a desired view 21 from the library 14 of image information. All or some of the image information sent to the display 10 can be streamed, and/or some or all of the image information can be stored on the display 10, where the system streams the rest. Embodiments include a combination of onboard storage and the ability to stream and make efficient use of both, depending on the user's Internet connection.

In embodiments, via a user interface, such as a gesture sensor 17, the user can select a single view 21, a montage of views, etc., from any one or more locations, e.g., a winter view in the mountains, a summer view by the sea, etc. The gesture sensor 17 can be located in the display 10 or in a windowsill or shelf associated with the display 10. An example windowsill 1708 is illustrated and described in more detail with reference to FIG. 17. The gesture sensor 17 can also change the volume shown on the display 10 in a manner that is consistent with the motion of lifting a window up or lowering it. In some embodiments, the one or more processors 12 provide a signal to a haptic feedback device 23 located within the electronic display 10 or on a shelf or windowsill below the electronic display 10. The signal instructs the haptic feedback device 23 to provide haptic feedback to the user. For example, the haptic feedback device 23 is provided such that operating the virtual window gives the sensation of the window sliding in a track, etc.

In some embodiments, the processors 12 send audio signals to a speaker 15 located proximate to the electronic display 10. The speaker 15 plays ambient sounds associated with the video. For example, the speaker 15 associated with the electronic display 10 plays ambient sounds associated with the view 21. The speaker 15 can be located at the electronic display 10 or in a ledge or shelf associated with the electronic display 10. Such sounds can be captured in real time with a microphone (not shown) that is part of the camera 22 (e.g., a webcam or other type of camera) used to stream the view 21, or the sounds can be recorded with a stored view. For example, a sunrise view can be accompanied by bird song. In embodiments, the actual sounds can be edited or enhanced. For instance, when a video recording is made at, for example, Big Sur, California, it is preferred that noises, such as car noises or noises of the crew talking by the camera, be edited out of the recording.

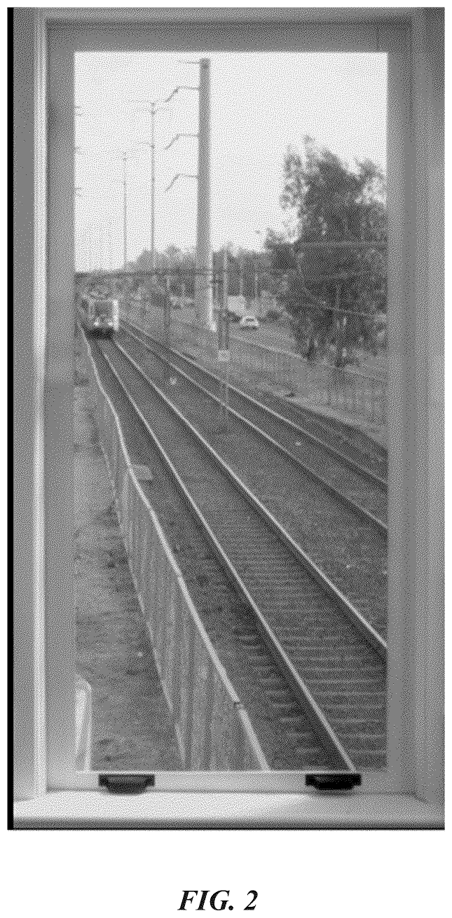

FIG. 2 illustrates a view of an urban area displayed using a virtual window, in accordance with one or more embodiments. The image or video information can be of a user's location, e.g., a view that one would expect if the virtual window was an actual window, or the image information can include a view from any location, e.g., the user can access a desired view from a library of video information (e.g., library 2912 shown by FIG. 29). An example electronic display 10, library 14, and view 21 are illustrated and described in more detail with reference to FIG. 1. An example virtual window 1512 is illustrated and described in more detail with reference to FIG. 15. In some embodiments, a camera (e.g., a webcam or other type of camera) is placed on an outer wall of a structure at a place coincident with where the electronic display is placed on an inner wall. An example camera 22 is illustrated and described in more detail with reference to FIG. 1. The camera streams a video to the electronic display that includes the view that would be seen if an actual window was at the location where the electronic display is placed. Embodiments also place cameras in various locations around the world to provide a live view, not just on the outer wall of their structure but at all of these other locations. As mentioned above, the user can select among these views or can set a random or programmed location among these views.

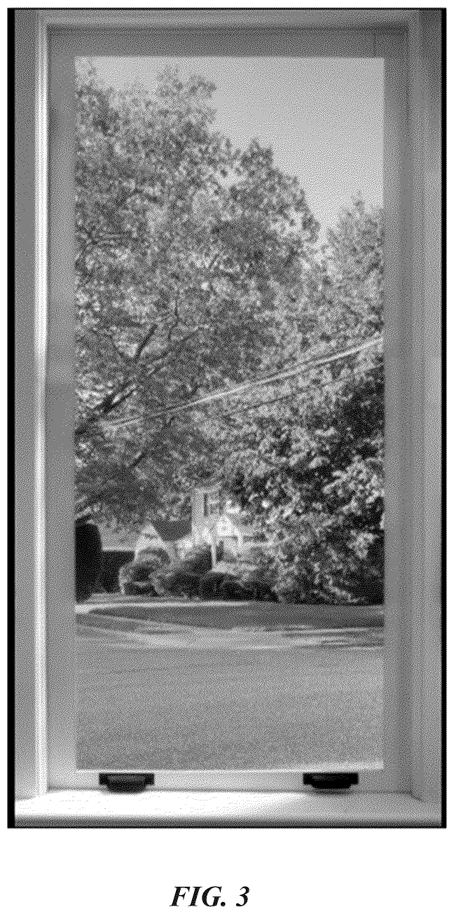

FIG. 3 illustrates a view of a suburban area displayed using a virtual window, in accordance with one or more embodiments.

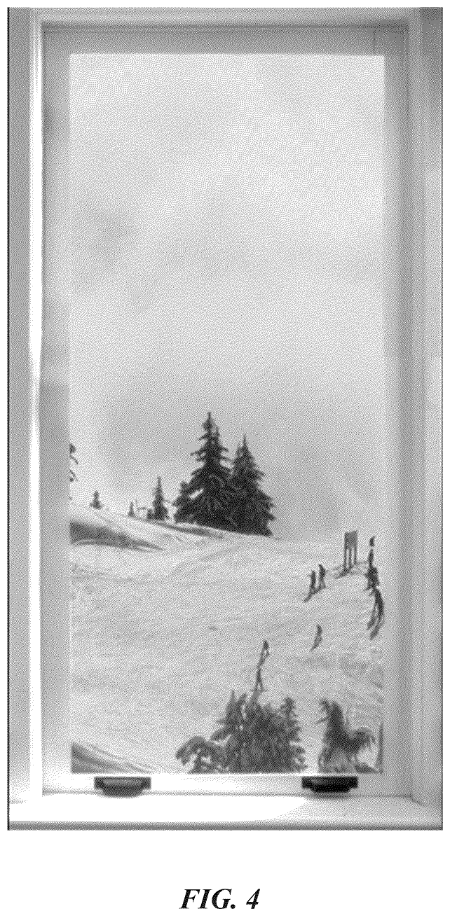

FIG. 4 illustrates a winter view displayed using a virtual window, in accordance with one or more embodiments. In some embodiments, one or more processors are configured to retrieve current weather conditions from live, online data. Example processors 12 and a database 13 are illustrated and described in more detail with reference to FIG. 1. The processors can modify the video to depict the type of weather within the view. An example view 21 is illustrated and described in more detail with reference to FIG. 1. For example, the weather is detected via the live, online data, and the weather characteristics found in the online data are added to the video, e.g., snow or rain, and then displayed. An artificial intelligence algorithm can be used to add the digital weather effects to the view.

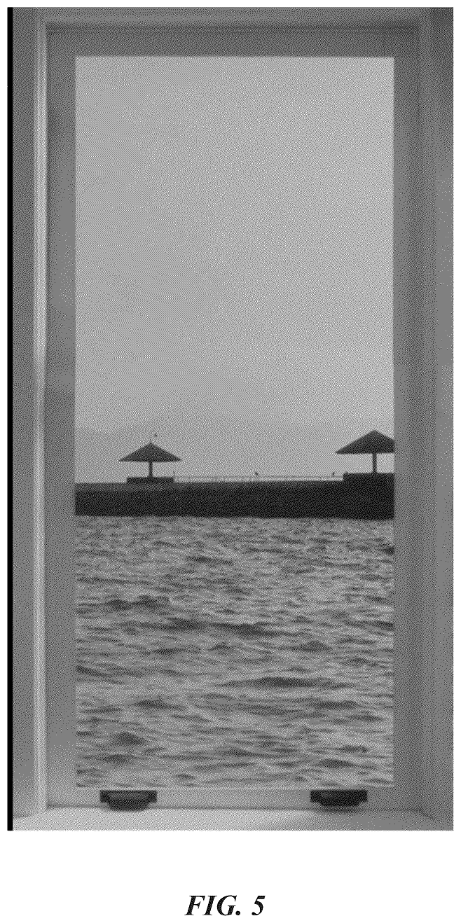

FIG. 5 illustrates a tropical view displayed using a virtual window, in accordance with one or more embodiments. One or more processors can synchronize a time-of-view at the geographical location captured by a camera (e.g., a webcam or other type of camera). The time-of-view in the video is synchronized with a time-of-day at a user's location. An example camera 22 and processors 12 are illustrated and described in more detail with reference to FIG. 1. For example, video of a view is played on an electronic display, where the video of the view syncs with the actual time-of-day at the electronic display. An example electronic display 10 and view 21 are illustrated and described in more detail with reference to FIG. 1. The processors can synchronize a length-of-day at the geographical location in the video with a length-of-day at the user's location. For example, an entire day from sunset to sunrise is accurately represented, and many hours are shot, photographed, and streamed at each geographical location to cover the time before and after sunrise and sunset to be accurate in each location.

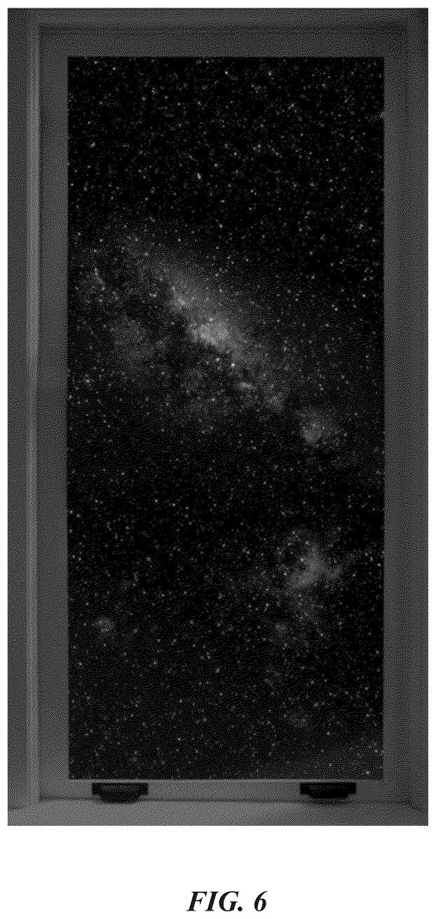

FIG. 6 illustrates a view of a night sky, in accordance with one or more embodiments. In some embodiments, the view of the night sky is an animated three-dimensional (3D) model that is simulated to appear photorealistic to a user's eye.

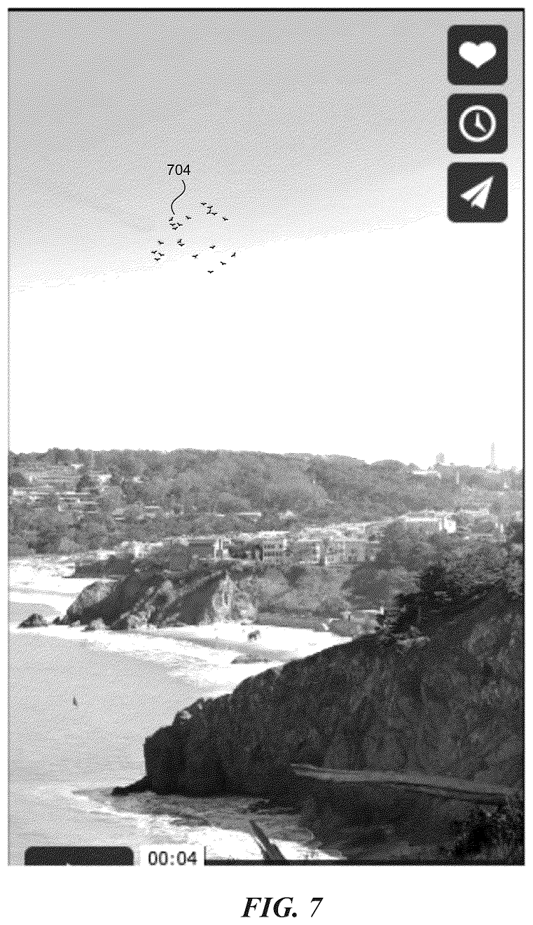

FIG. 7 is a screenshot of an example event displayed using a virtual window, in accordance with one or more embodiments. The event includes birds 704 flying across a view. The screenshot in FIG. 7 also shows optional icons displayed at the top right of the virtual window and a time code at the bottom of the virtual window. The icons and time code can be displayed by a user or a person implementing the virtual window using display options for extra information. FIG. 7 illustrates embodiments in which a video of a view is augmented with a photorealistic object or animated object for displaying in the view. Movement of the object(s) in the view is referred to as an event. At least one feature of the photorealistic object or animated object can be modified based on the time-of-view at the geographical location. For example, the processors can insert photorealistic, animated, or fantastical objects into a view to provide variety and customization to pre-recorded or live video content or photographic content. A user can choose to add a sailboat, the birds 704, or a horse into a view at day or night to give a greater sense of reality in video that is looped and repeated by adding randomness of objects to the footage. For example, FIG. 7 shows an unexpected event in which the birds 704 fly across the sky.

Additions to a video can also include 3D topography of a view, metadata gathered via an online database, 3D mapping techniques using stereo cameras, etc. As the time-of-day changes, the objects' lighting is changed in synchronization to a location of the sun to make the video even more realistic. The objects can be pre-rendered or the lighting can be altered and then be rendered in real time based on the time of day using sun and location tables either in the cloud or on an electronic display based on the location of the virtual window. In some embodiments, features of each object are randomized within realistic bounds, such as a number of the birds 704 in a flock, each bird's wing-flapping speed, or speed of each bird in the flock to make it feel more real and not simply a video loop being added. In embodiments, the unexpected objects could be in the form of unexpected events that occur at varying or regular intervals. Further, the unexpected objects can interact with 3D and other aspects of a view, for example, an elephant would appear to walk up the slope of a beach in a realistic fashion.

In some embodiments, a user can, through an interface (e.g., the user device 1504 illustrated and described in more detail with reference to FIG. 15), choose to have an “unexpected objects setting” ON or not. The user can choose different permutations that include many or a few of these and settings in between and if they should occur during specific times or all day. In other embodiments, an application programming interface (API) connects to third-party apps to control the unexpected objects or event, when and how the objects are inserted, and which objects are inserted. An API can also connect to a third-party app to modify the video itself.

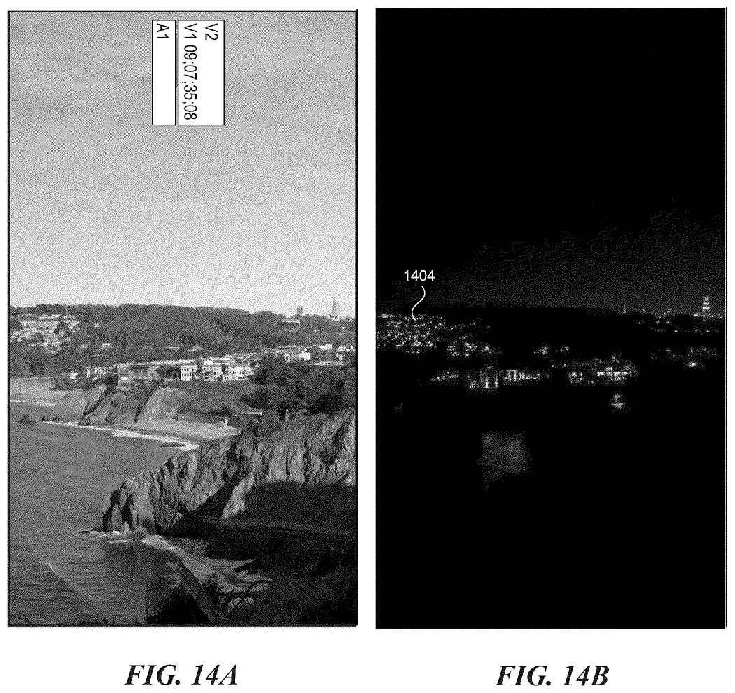

Some events are only visible during the day (e.g., see FIG. 14A) when there is illumination to see the objects. For instance, a boat in the water might not be visible during the night (e.g., see FIG. 14B) unless it moved over a light reflection in the water or it had its own lights. Birds flying at night over a dark sky would not be visible. A user can also include the types of events they desire for a specific view from a library of objects through a variety of interfaces, e.g., a user device, a computer, gesture controls, remote control, facial recognition of different people in the home or office, etc., to select natural elements such as birds and people or physical elements such as boats and airplanes. Natural elements can match what would occur in nature, so an elephant would not appear on a beach in Florida but would in Thailand. A user can also select a fantastical setting where an elephant appears on the beach in Florida or a dragon flies across the view.

In some embodiments, objects in a view move and interact with the environment appropriately, so a boat is depicted only on water and not in a city. For example, birds cannot fly through a tree but behind or in front of it. Similarly, some objects are not visible in the evening unless they have light emitting from them, such as lights on a boat in the water (e.g., see FIG. 14B). The objects that are night friendly may be noted as such on a user interface. In some embodiments, events are gamified, such that users can play a game where they look for objects that are hidden in each view. Users can also add their own objects and share them with any of their friends who have virtual windows that are connected to a shared virtual window system.

In some embodiments, a video is augmented by receiving a video clip. The video clip includes a portion of the video and a photorealistic object or animated object. The video clip (sometimes referred to as a “clip”) is a shorter portion of the video. One or more processors composite the video clip into the video at the time-of-view at the geographical location. For example, a team of artists and animators create each object using software-based tools. Once the objects are approved, they are placed in the view with the appropriate lighting for the time-of-day and to make the objects interact correctly with other parts of the view, e.g., birds cannot fly through a tree, they need to fly behind it, around it, or in front of it. A trajectory can be designated where specific objects move within each view.

Because events can occur at any time-of-day, where the lighting changes based on the sun or objects that emit light in each view, a video clip can be customized to feel authentic to the time-of-day when placed in a view. For instance, placing a flock of birds at 3:25 PM with birds that were rendered and lit from a view at 7:00 AM would yield unsatisfactory results, with the birds feeling fake because the lighting appears to be inauthentic to that time-of-day. Dozens of variations for each object can be rendered to correspond to various times-of-day and have differences in speed, direction, number, etc., to avoid appearing like a video loop. In embodiments, video clips are rendered ahead of time, stored in the cloud, and then sent to a virtual window to be inserted in the longer view footage at a precise time. For instance, birds appearing at 3:25 PM are composited for that specific time, sent to the virtual window, and then inserted precisely at that time so as not to cause a jump in the video, i.e., an uneven or jerky transition as opposed to a smooth, seamless transition.

In some embodiments, an amount of compression of the view video matches an amount of compression of the video clip. For example, the compression of both the view video and the video clip is exactly the same or matches, such that edits to the video are not noticeable. The compression of the original video (the view) and of each clip is kept the same for the unexpected event to be undetectable by a user. If the view was compressed at H.265 and the clip at H.264 or at H.265, but not the exact same settings, the clip would not match when it is inserted into the view and would break the illusion. Advanced Video Coding, also referred to as H.264 or MPEG-4 Part 10, is a video compression standard based on block-oriented, motion-compensated integer-DCT coding. High Efficiency Video Coding, also known as H.265 and MPEG-H Part 2, is a video compression standard designed as part of the MPEG-H project as a successor to the widely used Advanced Video Coding.

In some embodiments, the compositing of video and lighting modification is performed on the client side of the virtual window. The “client,” “client system,” and “client virtual window system” refer to the combination of one or more processors, memory, and the electronic display that make up the virtual window. In some embodiments, standard objects are stored in a library and rendered on the fly as appropriate for the time-of-day that the object is to be displayed. An example electronic display 10 and library 14 are illustrated and described in more detail with reference to FIG. 1. For example, a generic flock of birds can be displayed at any time-of-day once they are rendered in real time to exhibit appropriate lighting. As well, local weather conditions can be taken into account when rendering an object. For example, the sails in a sailboat can flutter in accordance with the true velocity and direction of the wind.

Some embodiments disclosed herein reduce the need for the processors or electronic display to download an entire updated view each time there is a change to the view, such as with time synchronization or with unexpected events, or other features. A virtual window system (as illustrated and described in more detail with reference to FIG. 1) can perform time synchronization in multiple ways. A time-of-view (the particular time that a point in the video was recorded) at a location is synchronized to play at a matching time-of-day at a viewing location. For example, images recorded at 8 AM at the location where the video was shot are played when it is 8 AM at the user's location. A length-of-day of a location in the video can be synchronized with the length-of-day at a viewing location. For example, the video is shortened or lengthened to match the length-of-day at the user's location. The time synchronization artificially synchronizes the time-of-view in the video displayed in the virtual window (e.g., the sunrise and sunset) with the physical location of the virtual window (or any chosen location) to mimic a 24-hour day such that the lighting displayed in the video is consistent with the time-of-day in each location.

In embodiments, each view is typically 24 hours long and can be about 150-170 GB (or larger) in size. Hence, the embodiments disclosed obviate downloading the entire file, e.g., 150 GB (or larger) repeatedly. The video in the view is modified without the user observing this. In some embodiments, editing is performed using a dissolve and is timed carefully. A dissolve (sometimes called a lap dissolve) is a gradual transition from one portion of a video to another. A dissolve overlaps two shots for the duration of the effect, usually at the end of one scene and the beginning of the next. The use of a dissolve indicates that a period of time has passed between the two scenes. Because the virtual window system can process, for example, 4K 30 FPS video, video effects such as dissolves cannot be easily performed on the electronic display. Thus, compositing may be performed beforehand and stored in a library of video clips. The video clips are relatively smaller in file size and length because they only represent short scenes, such as birds flying through a view or a dissolve to bridge rewinding a view for time synchronization. In embodiments, the clips are from approximately 4 to 20 seconds or longer if necessary. Such files are more efficient to transmit to the electronic display because of their relatively smaller size. When content for unexpected events or time synchronization is added, an increase in efficiency is therefore achieved since the video clips generated are in a range from approximately 4 to 20 seconds.

An entire view can be downloaded into a client virtual window that has onboard storage. Embodiments use video codecs designed for higher resolution, lower framerate, and events insertion. If an object is added, e.g., birds 704 flying across the screen at 3:25 PM, the time is important because the user expects to witness an entire day on their virtual window as a seamless video with no cuts or interruptions. At 3:25 PM, the sun is at a specific height, and if there is a view of a beach, the waves are crashing on the shore at a certain rate, people are walking on the beach, and other activities are happening at this specific time, etc. The birds 704 flying across the screen also need to have their lighting set for 3:25 PM.

In an example, if “San Francisco View #1” has 120 clips of “Birds A” (a group of 10-30 sparrows flying together from left to right) at various times of day, which includes the actions for Birds A at 3:25 PM, then the clip corresponding to 3:25 PM is sent to the virtual window before the time this clip is to be used, in this case, 3:25 PM, for insertion at a specific time-of-day. Before the 3:25 PM event of the birds 704 occurs, the 3:25 PM clip of “Birds A” is sent to the virtual window. For example, this clip has lighting and a trajectory that is correct for the specific time and the specific view and is 5 seconds in length. The virtual window saves this clip on the onboard storage. When the virtual window plays the view at 3:25 PM, this clip is insert-edited precisely at 3:25:00 PM and then the original view resumes playing from the same point the 3:25 PM clip finishes, in this case, at 3:25:06 PM. As such, the birds 704 fly across the view in the virtual window with no interruption. If the insertion of the birds 704 is not done in this manner, there would be a jump cut, i.e., if the clip was placed even a second or less before or after the specific time, it would create a momentary omission in a continuous shot, resulting in an effect of discontinuity. If the lighting did not match, this would be noticeable as well. Depending on whether or not the clip is to be used at the client at a future date, it is either saved on the client virtual window or deleted.

For time synchronization, the video efficiencies work similarly. A virtual window system (as illustrated and described in more detail with reference to FIG. 1) can perform time synchronization in several ways. A time-of-view (the particular time that a point in the video was recorded) at a location is synchronized to play at a matching time-of-day at a viewing location. For example, images recorded at 8 AM at the location where the video was shot are played when it is 8 AM at the user's location. A length-of-day of a location in the video is synchronized with the length-of-day at the viewing location. For example, the video is shortened or lengthened to match the length-of-day at the user's location. The time synchronization artificially synchronizes the time-of-view in the video displayed in the virtual window (e.g., the sunrise and sunset) with the physical location of the virtual window (or any chosen location) to mimic a 24-hour day such that the lighting displayed in the video is accurate for the time-of-day in each location. In embodiments, a short, approximately 3-5-second video clip is used to add or subtract time in a view to match the time-of-day. The approximately 3-5-second clip can be a dissolve between two videos, either extending the time or compressing it, as appropriate. The dissolve is used to hide the fact that the view was edited. Time synchronization either adds time to or subtracts time from a view to allow synchronization with the location of a virtual window based on the sunrise time and sunset time. Because every day has a slightly different sunrise and sunset time, the video footage is augmented daily. Without video efficiencies, this would mean sending a new 150 GB (or larger) file to the client every day.

Time synchronization can be used to add time as follows. On installation, a virtual window is initialized with its geographical location, for example, by using a location obtained from a GPS system, together with sunset/sunrise information drawn from the Internet. In some embodiments, predetermined tables are used in case Internet connectivity is not available. The video synchronizes to the sunrise and sunset times at the geographical location.

Synchronizing the length-of-day in a video with the length-of-day at the user's location can be performed by rewinding a portion of the video responsive to the length-of-day at the user's location being longer than the length-of-day in the video. The processors of the virtual window replay the portion of the video. For example, consider a view that was shot on January 19, and that day is 9:48:26 long (expressed in hours, minutes, and seconds). The sunrise is at 7:19 AM, and the sunset is at 5:09 PM. The user is looking at this view on July 8, when the length-of-day at the user's location is 14:48:05, with the sunrise at 5:44 AM and sunset at 8:32 PM. In this case, the daylight from the day that the view was shot, January 19, needs to be extended by 4:59:30. To do this, the video of the view needs to play to a certain point and then rewind several times to extend the length. The procedure is performed several times to reduce the change in daylight in the view between points such that the change is not or hardly noticeable to the user. Therefore, at 11:30 AM, the video is rewound to 10:30 AM, adding one hour of daylight. For illustration purposes only, the step would be performed again at 12:30 PM, 1:30 PM, etc., until the length-of-day is accurate for July 8, adding enough time to the day for sunset to be displayed in the video at 8:32 PM.

If the procedure was performed by a simple edit, there would be a jump cut when the footage was rewound and played again. Not only does the brightness of the sun lighting the view change between 11:30 AM and 10:30 AM, but if it were a view of a beach, the waves and the people on the beach would appear to jump as the video was rewound by one hour and just played back—as things would be in different places and would ruin the illusion of the virtual window. To remedy this, a simple 3-5-second video dissolve is added between the shots. A dissolve is added between the shot at 11:30 AM and the shot at 10:30 AM, blending the scenes and significantly reducing the visibility of the cut. In some scenarios, it is desirable to jump ahead instead of rewinding. For example, where the view is shot during the summer and there are 14 hours of daylight, but the user wants to watch the view during the winter, time in the video is compressed, i.e., to move forward to another time.

In some embodiments, a 5-second clip of a dissolve is either created in the cloud or on a video editing system and stored in the cloud, then sent to the client virtual window, where it is used to add one hour to the view. The “client,” “client system,” and “client virtual window” refer to the combination of one or more processors, memory, and the electronic display that make up the virtual window. The video on the client virtual window would play, and then at 11:30:00 AM, the virtual window plays the clip with the dissolve, bridging 11:30 AM to 10:30 AM, and then the video continues playing from the 10:30:05 mark. In some embodiments, the video clip is pre-rendered because some virtual windows may be unable to perform a high resolution and high framerate dissolve in real time. In some embodiments, it is possible to perform a high resolution and high framerate dissolve in real time on the virtual window, saving resources in pre-rendering and saving the clips to the cloud. When the high resolution and high framerate dissolve is performed in real time locally on the virtual window, the time synchronization feature runs in the background while the virtual window is playing the video, displaying the interface, etc.

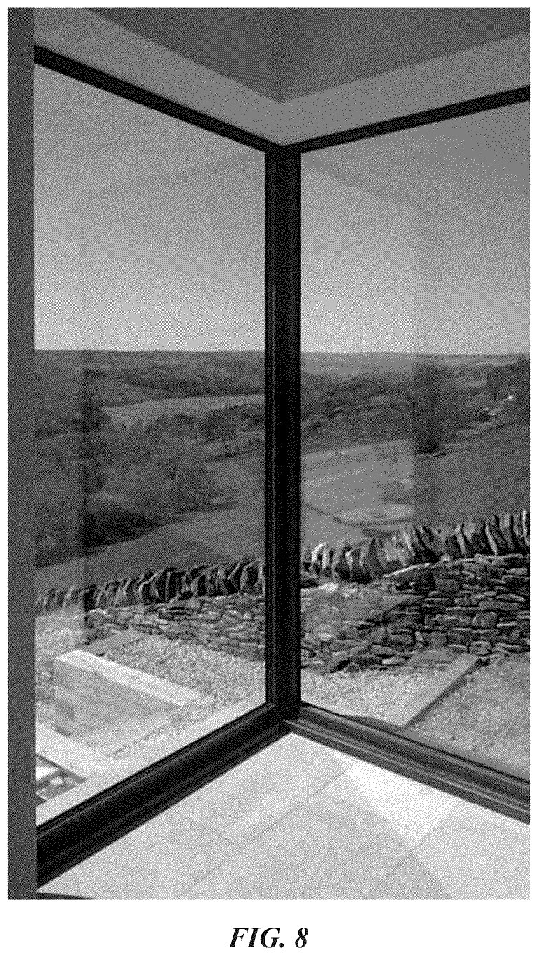

FIG. 8 illustrates example images of two corner windows displayed on a virtual window, in accordance with one or more embodiments. The virtual window shown in FIG. 8 mimics actual corner windows. For example, computer software can take a view and project it onto the corner windows by warping or reconfiguring the view to account for the corner windows configuration. In other embodiments, two virtual windows can be placed at a corner of a room such that each virtual window is perpendicular to the other. The two virtual windows thus have 90-degree views. Corner virtual window panels act similarly to panorama virtual windows because the content goes across both virtual windows but at 90°.

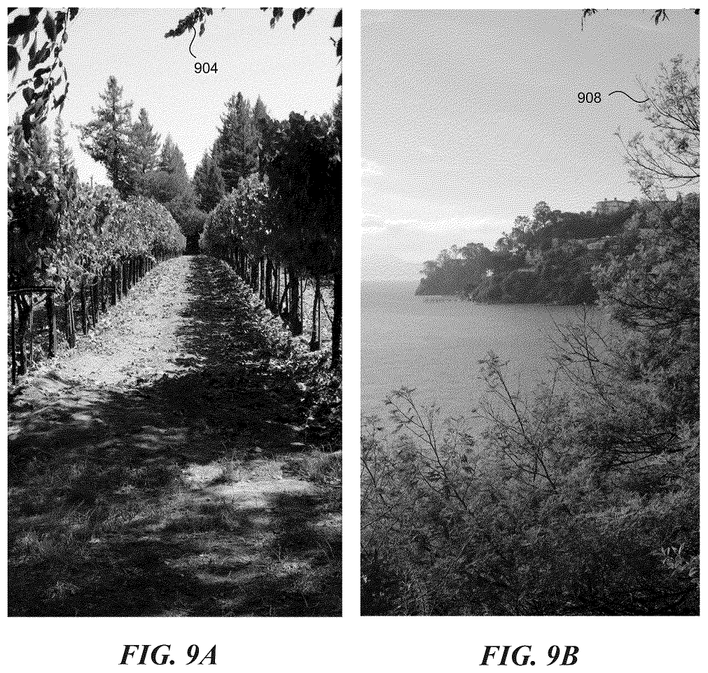

FIGS. 9A and 9B illustrate example views having objects 904, 908 in the foreground displayed using virtual windows, in accordance with one or more embodiments. The virtual window views having the objects 904, 908 (branches and leaves) in the foreground simulate the views from actual windows. The composition of a view displayed by a virtual window (e.g., the virtual window 1512 illustrated and described in more detail with reference to FIG. 15) is different from a composition of a landscape photograph, for instance. In fact, if a photographer from Sunset magazine was shooting a similar view for the magazine, as compared to the virtual window, they would look different. Views from actual windows, unless they are unobstructed, such as on a cliff or on a high floor in a tall building, usually have objects in the foreground, e.g., a branch, a top of a fence, a railing, etc. A view from the virtual window has detail mimicking actual windows that ties a view to the geographical location. In addition, the views for the virtual window have objects in focus, and nothing is blurry, as with an actual window. In embodiments, there preferably is a slight movement in each view, such as leaves slowly moving because of wind, to render the video more realistic than a still image.

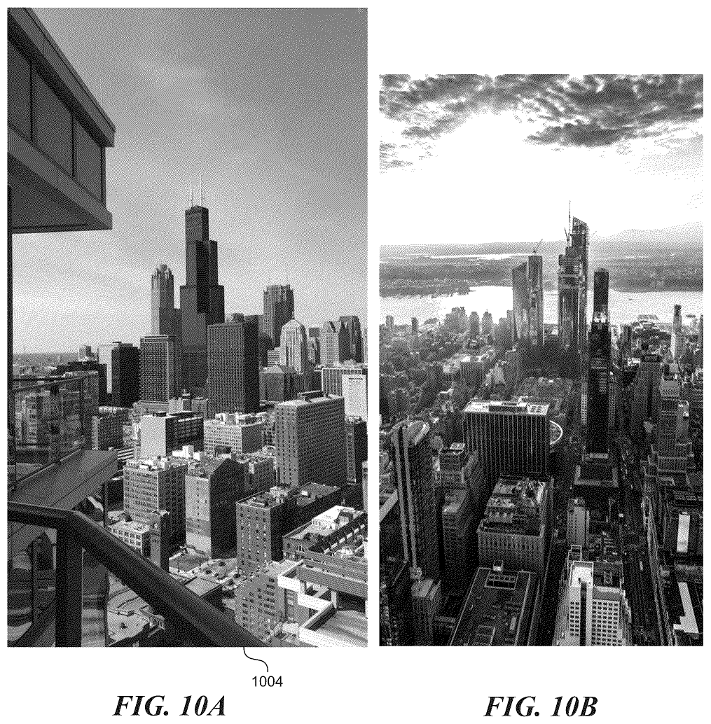

FIG. 10A illustrates an example view having an object 1004 in the foreground displayed using a virtual window, in accordance with one or more embodiments. FIG. 10B illustrates an example view lacking an object in the foreground displayed on a virtual window, in accordance with one or more embodiments. The view in FIG. 10A shows a railing 1004 in the foreground to give a sense this is an actual window. The view in FIG. 10B lacks the railing in the foreground and does not feel as real or authentic as the view in FIG. 10A. It is preferred to have objects in the foreground for a view to be realistically composed, although other embodiments do not have objects in the foreground. In some embodiments, an image of a foreground object is generated for displaying on a virtual window. The foreground object is to provide the illusion of an actual window located in the geographical location to the user. For example, even when an unobstructed view is possible, it is advantageous to have an object in the foreground to enhance the illusion of an actual window. Notice the railing 1004 in FIG. 10A, which makes the view more realistic, as if it is from an actual window.

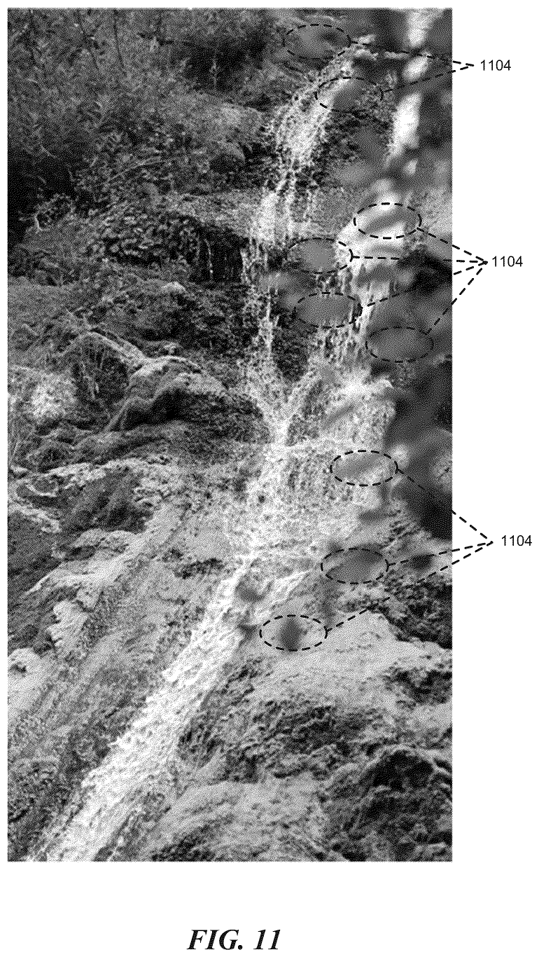

FIG. 11 illustrates an example unacceptable view having blurred leaves 1104 displayed in the foreground, in accordance with one or more embodiments. The view in FIG. 11 would be unacceptable for use as a virtual window view since a user's eyesight would not be normally blurred in such a manner.

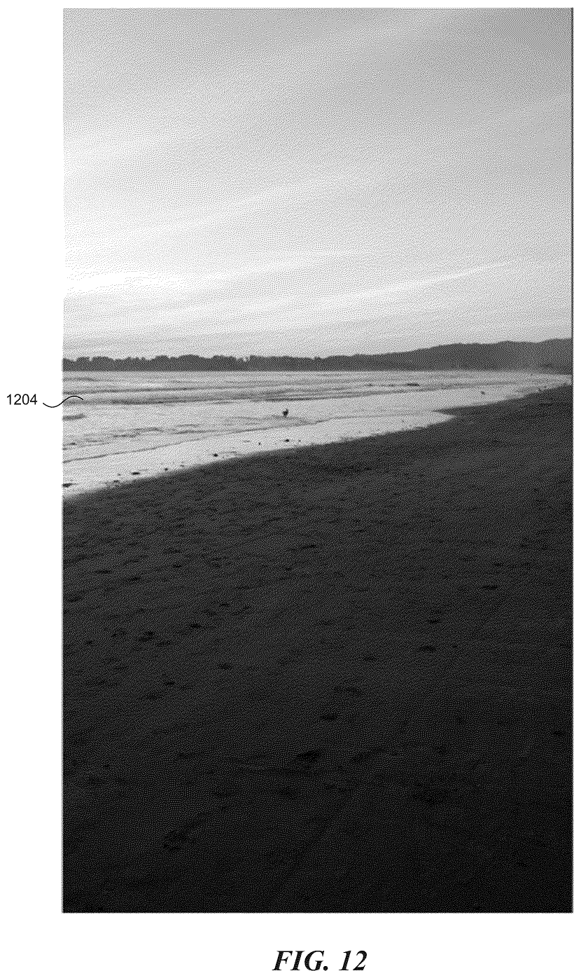

FIG. 12 illustrates an example unacceptable view displayed using a virtual window, in accordance with one or more embodiments. The view in FIG. 12 is of a location 1204 a few feet from an ocean and would be therefore unacceptable for a virtual window view because there would not normally be a structure that has an actual window in such a location. Moreover, as the tide changes, a tripod holding a camera at such a location 1104 would be under water or, at low tide, the ocean would be far away.

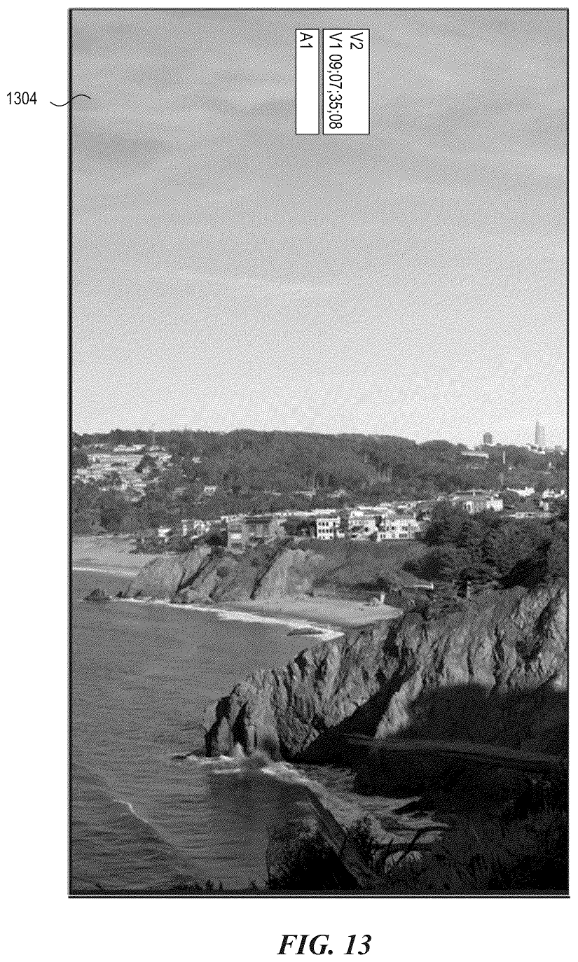

FIG. 13 is a screenshot of an example view on a virtual window where approximately half the frame shows the sky 1304, in accordance with one or more embodiments. The screenshot in FIG. 13 also shows an optional time code displayed at the top of the virtual window. The time code can be displayed by a user or a person implementing the virtual window using display options for extra information. The view shown in FIG. 13 has foreground elements at the bottom. When the sky 1304 is showing, approximately 50% of the frame is of the sky 1304, mimicking the view of an actual window. As with most actual windows, the field of view of the virtual window includes an amount of sky 1304, assuming the sky 1304 is not obscured (e.g., from inside a forest or having trees or other objects obscuring the sky 1304). The virtual window views are typically composed with approximately 50% of the composition including the sky 1304, as would be the case if the user were looking straight ahead from an actual window. So, if someone was above a beach, or even on a beach or a flat plateau, to create an authentic-looking view from a window, the field of view would include much of the sky 1304.

FIG. 14A illustrates an example day view of a particular area displayed using a virtual window, in accordance with one or more embodiments. In some embodiments, synchronizing the length-of-day in a video with the length-of-day at the user's location is performed by increasing or decreasing an amount of time a portion of the video is displayed on the virtual window. For example, a virtual window shows 24 hours of video of a view and matches sunrise through sunset to be accurate in each location. The video can be synchronized in real time with rising and setting of the sun in the location where the user has installed the virtual window. The length-of-day at the user's location changes daily. One day can have 14.5 hours of sunlight, with sunrise at 5:17 AM on one day and sunset at 8:50 PM. On December 7, the sunrise can be at 7:12 AM and sunset at 4:51 PM, with 9.5 hours of daylight. In some embodiments, the virtual window retrieves the local sunrise/sunset times in sunrise/sunset tables and then automatically modifies the pre-recorded video to shorten (or lengthen, as the case may be) the time the video is displayed without showing a “jump cut” such that the daylight hours of the display and the actual daylight are coincident.

FIG. 14B illustrates an example night view of the particular area displayed in FIG. 14A, in accordance with one or more embodiments. There are visible lights 1404 and some lights that cannot be readily seen, such as stars and planets that are in the video as well. Virtual window views typically have a single composition that works for both day and night without moving the camera. This often means other light sources are needed in a view, such as windows, fires, boats with lights, airplanes, etc. A beautiful mountain view would work better as a virtual window view if it was under a full moon and you could actually see the mountain and/or there were lights/campfires on the mountain. A view in the evening without ambient light would not work as well for a night view, as the composition would be completely dark. Additionally, because of limitations of the sensitivity of video cameras, the stars, satellites, and planes may not be visible in a night view. In some embodiments, a video of night skies is augmented, e.g., using an artificial intelligence algorithm, with digital stars, planets, and other objects that move in the sky to address issues of views needing more illuminated objects.

FIG. 15 is a block diagram illustrating components of an example system for generating soundscapes, in accordance with one or more embodiments. Users can generate custom soundscapes using the user devices 1504, 1508 to accompany the virtual window views by using controls within a mobile app (or other devices, including the virtual window 1512 itself) to adjust the volume levels of various sounds in the view per their preference. In some embodiments, a user is presented with multiple audio channels. For instance, a view of a jungle can include the sounds of wind, the sounds of rain, the sounds of the surf nearby, and the sounds of birds chirping. The user can choose to lower the volume levels of the wind channel but increase the sounds of the rain and birds channels. This feature provides customizability and improves immersion. The mix of sound channels can also be changed.

In some embodiments, a user device 1504 (e.g., a smartphone, a tablet, a computer, a controller, or another consumer electronic device) receives a command from a user. The controller can be a dedicated or universal remote control implemented using the components illustrated and described in more detail with reference to FIG. 27. The command indicates a type of window frame, casing, or muntin. An example window frame 1712, example casing 1704, and example muntin 1716 are illustrated and described in more detail with reference to FIG. 17. Casings refer to moldings that go around window frames. Casings can be installed outside a house to seal the window frame to the house, blocking cold air from entering the interior. Alternately, casings are the finishing touch to a window installation, similar to baseboards and door moldings. A window frame is the combination of the head, jambs, and sill that forms a precise opening in which a window sash fits. A muntin, muntin bar, glazing bar, or sash bar is a strip of wood or metal separating and holding panes of glass in a window.

One or more processors can retrieve the type of window frame, casing, or muntin from a library. A virtual frame, virtual casing, or virtual muntins or mullions to be displayed on a virtual window are generated to match the type of window frame, casing, or muntin. Generating a virtual frame or virtual casing can be performed by providing reflections of at least a portion of the view on the virtual frame or virtual casing. In some embodiments, an image overlaid on the view provides reflections of at least a portion of the view on the casing, the virtual frame, and the one or more optional muntins or mullions.

In some embodiments, in a home or office setting, a user interface device, such as a smartphone 1508, a computer interface, or other interface, e.g., in a dedicated controller, is provided using which the user chooses a virtual casing from a library of many window casings to match or get as close to as possible the user's taste and match what they already have installed with an actual window. In some embodiments, the virtual casing is composited on the display over the view being displayed in the virtual window 1512 to give the appearance of a real window casing.

In some embodiments, compositing an image with a video is performed by analyzing lighting, apparent color temperature, and/or content of the video. The lighting and apparent color temperature are adjusted to the image such that the illusion provided to a user includes the virtual casing being located at the user's location. For example, compositing is performed by analyzing the lighting, apparent color temperature, and content of the background video and adjusting the lighting and color temperature to the foreground image, i.e., the virtual window casing, to give a user the impression that the window casing is in the same location as the background. Because the quality of light changes over the course of a day, a view analysis engine can track such aspects of the view as lighting, temperature, hues, etc. As discussed herein, a virtual frame can be composited with the video to provide an illusion of an actual window. The color temperature, etc., of the virtual frame can be adjusted such that the virtual frame appears as a realistic window frame with its colors, shades, shadows, and the like reflecting the actual ambient conditions of light that would stream through a real window and impinge on a real window frame.

In some embodiments, a hue of the virtual casing changes as a time-of-day at the geographical location changes. For instance, if the background video is of a beach, the window casing appears to have the white light from the sand reflecting on it, as would be the case if the user were looking through an actual window at that scene. However, at sunset, the window casing can pick up an orange hue and become a little darker to match the ambient light from the sunset. When the sun sets, and there is only light from the moon or stars, the window casing changes again. The window casing changes gradually as the background video changes to let the user feel as if they are in that specific location at that specific time.

In some embodiments, as shown in FIG. 17, a physical window casing 1704 or frame 1712 is positioned over a perimeter of the electronic display. An image of a semi-transparent layer can be generated having dimensions matching the electronic display. The image is composited with the video to provide an illusion to the user of viewing a glass window. A semi-transparent layer can be composited with the background video to provide a realistic impression of glass in the virtual window. The user separately chooses a background/view from a library (e.g., library 2912 shown by FIG. 29) of views from all over the world that can be composited in the cloud. A server then sends the composited video to the display to play, download, or steam the content.

In some embodiments, the virtual window detects that a user device (e.g., the user device 1504) of the user is connected to a particular wireless network. The virtual window is connected to the same wireless network. An avatar of the user can be displayed on the virtual window 1512. When two users live in a household together, they can have a virtual window app controller on their user devices 1504, 1508. The users can choose objects that represent themselves, such as an avatar, to appear in the virtual window 1512 when they are in the same network as that of the virtual window 1512. The networking technology used can be Wi-Fi, Bluetooth Low Energy (BLE), or 5G and geolocation. For instance, user A can choose to be represented as an elephant and user B can choose to be represented as a bald eagle. When the network detects their user devices 1504, 1508 on the network, a bald eagle and elephant occasionally appear in the view. When user A or user B leaves the network or the location, or after a fixed amount of time when they are no longer visible to the facial recognition system, their avatars no longer appear.

In some embodiments, a view depicting a house is displayed in the virtual window 1512. The house is representative of a friend or colleague that has allowed a user to connect to the friend's house using the virtual window 1512. The friend can let the user know the friend is home by the system detecting the friend by their mobile device or other system that has the virtual window app installed. To show the friend is home on the user's virtual window 1512, for example, the drapes in the house in the view might be raised during daylight hours or the lights inside go on in the evening, thus indicating they are home.

FIG. 16 illustrates an example configuration for virtual windows, in accordance with one or more embodiments. In some embodiments, virtual window 1604 is mounted on the wall. The “on wall” version can sometimes be easier to install, mounted as a picture frame or a television. The “on wall” version can also have a window trim, windowsill, and acrylic or glass, as shown in FIG. 17. An “on wall” version hangs on a wall and protrudes from the wall, whereas an “in wall” version (used in the cavity 1608) is set into the wall itself. The virtual window 1604 can be positioned in a portrait or landscape configuration to fit visually best within the physical location in which it is placed. In a location having vertical windows or other such features, the virtual window 1604 is positioned vertically in portrait orientation to match the other windows. In an environment having horizontal windows or other such features, the virtual window 1604 is positioned horizontally in landscape orientation.

In other embodiments, a virtual window is configured to be embedded in an opening (e.g., cavity 1608) in a wall in the user's location, fully portable (carried by the user or a vehicle), attached to other objects, or itself part of another device in the user's location. For example, a virtual window can be embedded in the wall (e.g., in the cavity 1608) in a portrait or landscape configuration to match a layout of another window in the wall. The cavity 1608 illustrates a “backbox” used to encase the virtual window and place it within the recessed space (cavity 1608) in the wall.

In some embodiments, a user's experience is enhanced by placing two, three, or more virtual windows near or next to each other to create a panorama, a surrounding scene, or other juxtaposed effect, sometimes referred to as a “combined view.” Each view can be shot, for example, in 8K horizontal, allowing three 4K vertical views, one large horizontal view, or one panorama to be created. Such a combined view can be partially or fully achieved with existing display(s), physical window(s), or controller(s) that are already installed at the user's location. A user can benefit from a subscription to multiple views without the need for additional hardware, windows, or a controller. The virtual window embodiments disclosed herein further include an app or, in embodiments, a set-top box such as an Amazon Fire TVStick that can have a less-expensive subscription. In embodiments, horizontal content is preferred. Further, some content can be shot dynamically in different resolutions.

The virtual windows disclosed contain software and/or hardware that, if there are two or three virtual windows for a combined view, sense the other virtual windows and place each virtual window (e.g., the virtual window 1604) in a correct order (e.g., Left, Center, and Middle). Additionally, a user can assign the virtual window positions during setup. In some embodiments, a Bluetooth direction finding or location service is used. In other embodiments, a picture of the virtual windows that are part of a panorama is taken, and a smartphone app determines a distance and orientation relationship between the virtual windows. The information is sent to the code that splits the video stream into different video streams for each virtual window.

In embodiments, if a user decides to place two virtual windows on the same wall in a panorama with approximately 30-40 inches between virtual windows, the system assigns one virtual window the left position and the second one the right position to account for the physical space between each electronic display as shown in FIG. 16. Such placement provides an illusion of space between the virtual windows. For instance, if a horse rides by the left virtual window in a video, moving left to right, the horse crosses in front of the center virtual window, which in this case is not visible, but the time delay of not having the virtual window there simulates the horse moving in the space between the two virtual windows.

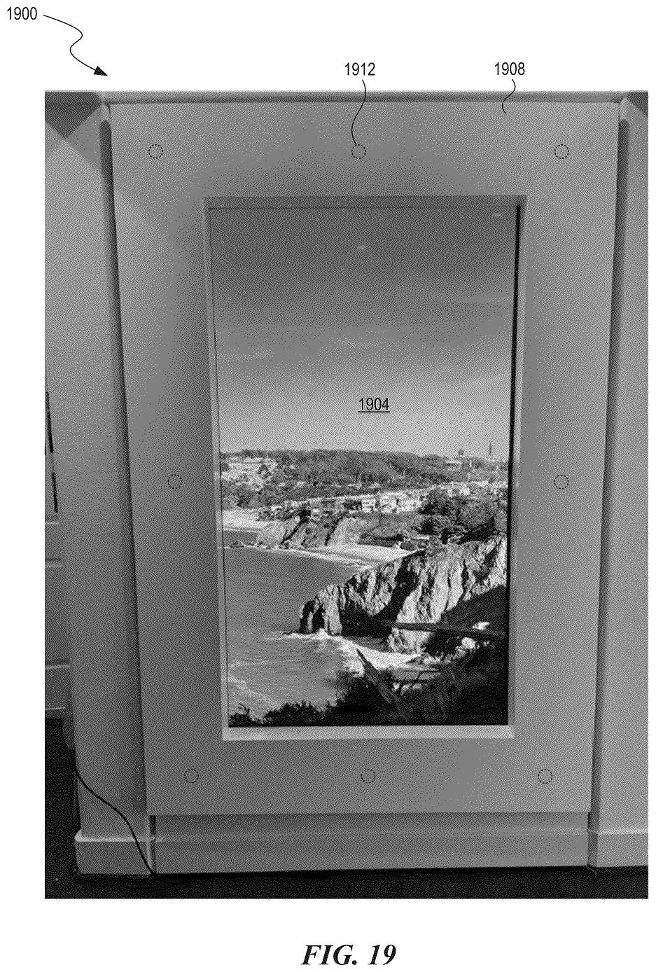

FIG. 17 illustrates an example configuration for a virtual window, in accordance with one or more embodiments. The example configuration includes a casing 1704 configured to surround a frame 1712 of the virtual window. The casing 1704 can be rectangular, oval, rectangular with rounded corners, etc. The casing 1704 can conceal one or more processors. The configuration shown in FIG. 17 is of a recessed, “in wall” window with classic trim (sometimes referred to as “Iv.classic” trim). The effect of the virtual window is enhanced if the window casing 1704, windowsill 1708, apron, and sash look like an actual window. The embodiment shown in FIG. 17 is called an “in wall” version of a traditional window with a sill 1708, apron, and molding. A window trim is used that mimics an actual window, including the use of acrylic to mimic glass from a window that has some of the same reflection properties as those of a glass window. A window grid, window muntins 1716, or mullions are optional features that can be placed between the acrylic and the electronic display. In other embodiments, as shown in FIG. 19, the virtual window 1512 is made to mimic a picture window of a solid piece of glass recessed in a wall.

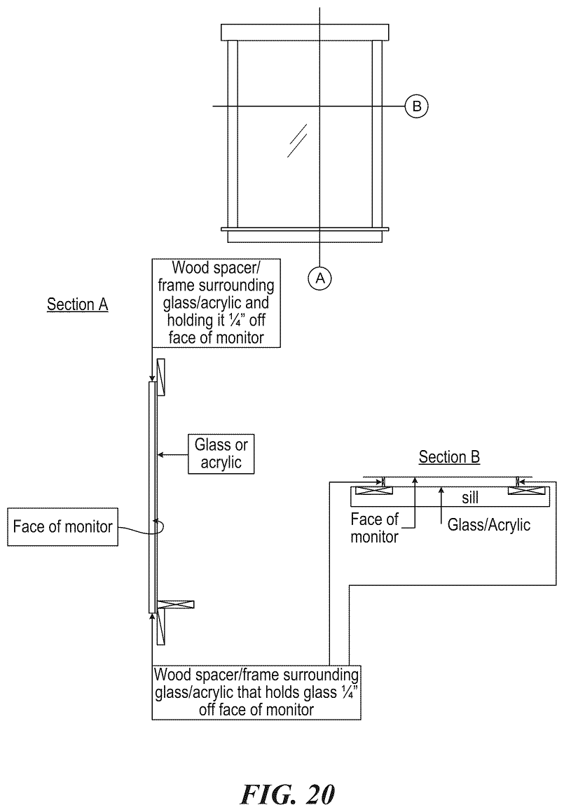

The casing 1704 is installed on a wall to seal a perimeter of the virtual window to the wall. One or more panes 1720 of glass or acrylic are attached to the casing 1704 and spaced from the virtual window by a particular separation. The separation is illustrated and described in more detail with reference to FIG. 20. The one or more panes 1720 are configured to permit a user located at a first location to view the virtual window through the one or more panes 1720. The panes 1720 provide first reflections of light to the user. One or more (optional) muntins 1716 or mullions are attached to the casing 1704 and configured to separate at least one pane of the one or more panes 1720 from at least another pane of the one or more panes 1720. The muntins 1716 support the one or more panes 1720 at the particular separation from the virtual window (as shown by FIG. 20). In some embodiments, the virtual window includes overlay elements that simulate the closing of blinds, shades, or curtains. For example, an image composited into the video by the processors includes at least one of blinds, shades, or curtains. The video can include a composited overlay of window blinds, shades, curtains, etc. Realistic operation of such blinds, shades, and curtains can be accomplished by user gestures. Because the frame and blinds, etc., are composited with the view shown on the virtual window, the user can select from a library of window frame types, blinds, and other coverings.

In some embodiments, the virtual window is embedded in the wall and surrounded by the rectangular casing 1704. The virtual window displays the video and (optionally) a virtual frame to provide a virtual window for viewing by the user. An example virtual frame 20 is illustrated and described in more detail with reference to FIG. 1. In some embodiments, the virtual window receives a signal from a camera, a sensor, or a microphone located on a shelf or a windowsill 1708 below the virtual window. The signal indicates a command from the user. The virtual window modifies the video based on the command. For example, the user can control certain aspects of the virtual window operation using gestures. In some embodiments, the user can use a computer interface (e.g., the user device 1504) and choose to view only sunsets, sunrises, or other specific features in multiple views that play for a fixed amount of time and then move to another view. For instance, the user can choose to watch the 15 minutes before and after sunsets all over the world, and after a sunset in Bali is played, the electronic display 10 displays a sunset from Maui. The user can further choose a playlist of content to have in their virtual window, as someone would choose a playlist of music.

The frame 1712 can be placed around the electronic display, e.g., to hide the display's bezel or for design if there is no bezel. In some embodiments, a small shelf or ledge 1708 is included at the bottom of the electronic display. The windowsill 1708 can include sensors for gesture and/or voice control and can contain and conceal one or more speakers. The shelf or ledge 1708 can also include devices to provide haptic feedback to the user, or the haptic feedback devices or speakers can be in the display 10 itself. Example speakers 15, gesture control sensors 17, and haptic feedback devices 23 are illustrated and described in more detail with reference to FIG. 1. In some embodiments, the physical windowsill or shelf 1708 affixed to the bottom of the electronic display is a design accent that hides the speakers and gesture control sensors.

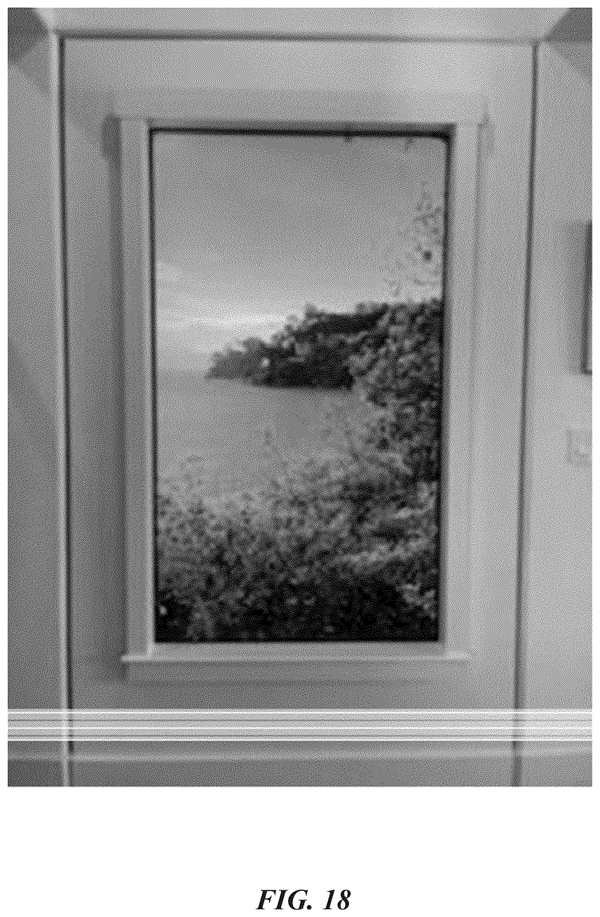

FIG. 18 illustrates an example configuration for a virtual window, in accordance with one or more embodiments. The configuration shown in FIG. 18 is of a recessed, “in wall” window with classic trim. Because each home is different, and a user can install their own window trim, sill, apron, sash, and grid and easily attach it to a window frame, a virtual window can be customized to match other windows already installed in the user's home or office. A generic window trim is also available. Both the generic window trim and a user's trim can also be painted to match a home or office in which a virtual window is to be installed.

FIG. 19 illustrates an example configuration for a virtual window 1900, in accordance with one or more embodiments. The configuration shown in FIG. 19 is of a recessed, “in wall” window in a modern trim (sometimes referred to as “Iv.modern” trim or configuration). The virtual window 1900 has no muntins, neither virtual nor actual. An “in wall” virtual window can be recessed into a wall like an actual window to enhance the user experience. Having the virtual window 1900 recessed in a wall makes the virtual window 1900 appear more authentic like an actual window. Also, having it installed in the wall also enables the hiding of power cables and other wiring, as well as electronics. The virtual window 1900 is readily removable from the wall for servicing without destroying the Sheetrock or other aspects of the physical area around the virtual window 1900.

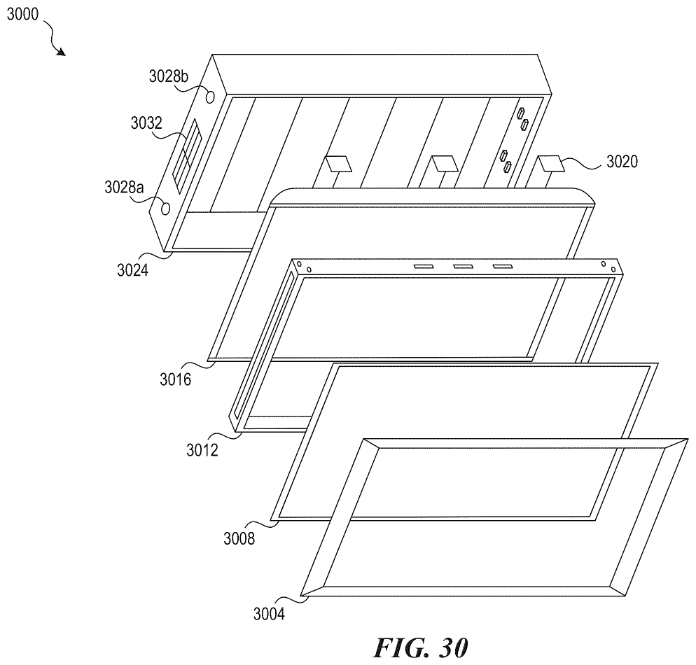

In some embodiments, the virtual window 1900 is recessed into a wall, e.g., as shown in more detail by FIG. 16. The virtual window 1900 includes a rectangular casing 1908 (sometimes referred to as a “frame”) configured to surround an electronic display of the virtual window 1900. The casing 1908 can be removably mounted on the wall using one or more magnets 1912 embedded in the casing 1908. For example, the casing 1908 can have magnets 1912 embedded within the casing 1908 or mounted on a rear surface or on a side surface of the casing 1908. The casing 1908 is therefore magnetically attachable to a backbox 3024 or a bracket 3012 (shown by FIG. 30) that is recessed into the wall to hold the electronic display. The casing 1908 is removable for cleaning, repair, or replacement. The backbox 3024 or bracket 3012 can be made of metal or other materials and can also have one or more magnets configured to secure or hold the casing 1908 in place. A layer 1904 of tempered glass (e.g., layer 3008 shown by FIG. 30) can be placed parallel to the screen of the electronic display and spaced from the screen. The glass layer 1904 protects the electronic display. Reflections of light (either from the electronic display or from outside the virtual window 1900) on the glass layer 1904 provide a more realistic impression of an actual window to a user viewing the reflections.

FIG. 20 illustrates an example configuration for a virtual window, in accordance with one or more embodiments. FIG. 20 shows the relationship between an electronic display, a spacer, and a layer of acrylic or glass in a “classic” design trim, a window casing design, and assemblies. The design principles shown in FIG. 20 are the same as for a “modern” trim. The spacing between the display and the acyclic or glass layer varies between 0-0.5 inches depending on the location of the virtual window installation in a particular location. The acrylic or glass layer is held in place by the window casing assembly. The distance between the electronic display, acrylic or glass layer, and the window trim can be unique for each virtual window, as shown in FIG. 20.

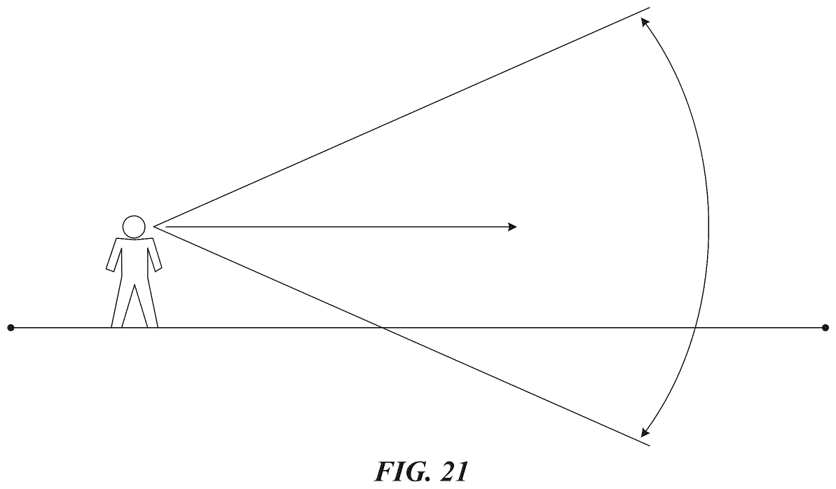

FIG. 21 illustrates an example field of view for a virtual window, in accordance with one or more embodiments. The field of view is the extent of the observable world that is seen at any given moment. The field of view can be a solid angle or a three-dimensional analog of an angle, such as that subtended by a cone or formed by planes meeting at a point. It can be measured in steradians. In some embodiments, the virtual window views have the perspective of looking straight ahead, as actual windows are almost always perpendicular to the ground and the field of view expands equally in all directions. The virtual window can be positioned horizontally or vertically.

FIG. 22 illustrates an example environment for virtual windows, in accordance with one or more embodiments. The virtual windows 2236, 2248, computer server 2204, network 2212, local network 2220, and user device 2228 shown by FIG. 22 can be implemented using components of the example computer system 2700 illustrated and described in more detail with reference to FIG. 27. For example, the devices shown by FIG. 22 can be implemented using the processor 2702 and instructions 2728 programmed in the memory 2706 illustrated and described in more detail with reference to FIG. 27. Likewise, implementations of the environment of FIG. 22 can include different and/or additional components or be connected in different ways.

FIG. 22 shows an interior of a home or office 2264 having a virtual window 2236 installed on the ceiling 2244 and a virtual window 2248 on a wall 2268. The virtual windows 2236, 2248 can have eye-tracking sensors and controllers and can use head-tracking, which changes the field of vision as user 2232 turns their head. The virtual windows 2236, 2248 can include imagers, sensors, displays, feedback devices, controllers, or the like. The virtual windows 2236, 2248 can capture data, locally analyze data, and provide output to user 2232 based on the data. A controller of a virtual window can perform local computing (e.g., edge computing) with or without communicating with remote server 2204 and can store edge computing machine learning (ML) libraries locally analyzing data to provide output. This allows onboard processing to be performed to avoid or limit the impact of, for example, communications over network 2212. Edge computing is a distributed computing paradigm that brings computation and data storage closer to the sources of data. This improves response times and saves bandwidth. Edge computing processes video data closer to the virtual windows 2236, 2248 and user device 2228, enabling processing at greater speeds and volumes, leading to greater action-led results in real time.

In some implementations, server 2204 receives (e.g., from user device 2228) a selection (e.g., within data 2208) of a first view 2252 (e.g., a scene in the country) for displaying on a first virtual window 2248 at a location (e.g., the location of building 2264). The view 2252 is selectable on the user device 2228 from among a library of views downloaded to the virtual window 2248. The first view 2252 can be a 24-hour video depicting a second location (e.g., a scene in a different city, state, or country) different from the location where the virtual windows 2236, 2248 are located. The video can be filmed using a digital movie camera having a camera angle corresponding to a horizon at the second location. The camera angle is set to the horizon to provide a more realistic impression of an actual window on the wall 2268. As described in more detail with reference to FIG. 21, the virtual window views have the perspective of looking straight ahead, as actual windows are almost always perpendicular to the ground and the field of view expands equally in all directions.

In some implementations, a lens of the digital movie camera has a focal length corresponding to a field of view of a human eye. The focal length of a lens is a fundamental parameter that describes how strongly it focuses or diverges light. The field of view describes the viewable area that can be imaged by a lens system. This can be described by the physical area that can be imaged, such as a horizontal or vertical field of view expressed in millimeters (mm) or an angular field of view specified in degrees. A fixed focal length lens, also known as a conventional or entocentric lens, is a lens with a fixed angular field of view that can also be used to implement the embodiments described herein. By focusing the lens for different working distances, differently sized fields of view can be obtained, keeping the viewing angle is constant. Angular field of view is typically specified as the full angle (in degrees) associated with the horizontal dimension (width) of the sensor that the lens is to be used with. The focal length of a lens used to implement the embodiments described herein defines the angular field of view. For a given sensor size, the shorter the focal length, the wider the angular field of view.

In some implementations, the video of the view includes audio recorded at a location. The audio can be used to create a soundscape, e.g., the sound of waves on a beach. The movie cameras used to shoot views are designed specifically for high-end digital cinematography use. These cameras typically offer relatively large sensors, selectable frame rates, recording options with low compression ratios or, in some cases, no compression, and the ability to use high-quality optics. For example, the professional digital movie cameras used to implement the embodiments described herein can include one or more of Arri Alexa, Blackmagic URSA, Blackmagic Pocket Cinema Cameras, Canon Cinema EOS, Panavision Genesis, Panasonic VariCam, Red Epic, Red Scarlet, Red One, or Sony CineAlta.

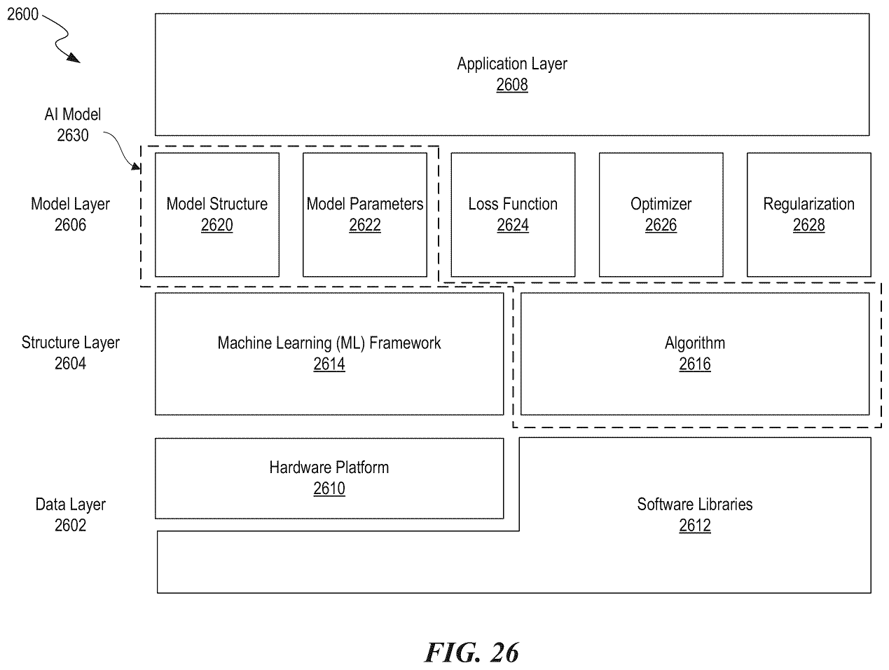

After video for the first view 2252 has been recorded by a camera, the server 2204 can generate (e.g., using the AI methods described in more detail with reference to FIG. 26) the second view 2240 (e.g., of a sky) corresponding to the first view 2252 for displaying on a second virtual window 2236 at the same location. For example, the second view 2240 corresponds to the first view 2252 and is generated in accordance with an orientation of the second virtual window 2236. An object can move across the second view 2240 before or after it moves across the first view 2252. The object has a second perspective in the second view 2240 based on a spatial relationship between the second virtual window 2236 and the first virtual window 2248.

The second view 2240 can be generated in accordance with an orientation of the second virtual window 2236 (e.g., flat on the ceiling 2244) at the location and/or a spatial relationship (e.g., a distance and angle) between the second virtual window 2236 and the first virtual window 2248. The server 2204 transmits the first view 2252 to the first virtual window 2248 for displaying on the first virtual window 2248. As described herein, the entire view 2252 (e.g., a 24-hour video scene in the country) can be downloaded onto the virtual window 2248. The virtual window 2236 can download the second view 2240 (e.g., transmitted via data 2216) from server 2204 for storage or display. Downloading of the view from the computer server 2204 to the virtual windows is controllable by a software application running on the user device operable by the user.

In some implementations, server 2204 detects one or more objects moving across the first view 2252. For example, the objects can be the birds 704 illustrated and described in more detail with reference to FIG. 7. The object has a first perspective corresponding to the first view 2252. For example, user 2232 sees a front perspective of the birds. The server 2204 can generate a video clip of the object for displaying in the second view 2240. For example, the second view 2240 shows the birds flying overhead across virtual window 2236 a few seconds after they cross the virtual window 2248. The appearance of continuous motion of the birds provides a realistic impression of a window on a wall (virtual window 2248) and a skylight (virtual window 2236) to user 2232. The artificially generated video clip of the object has a second perspective corresponding to the second view 2240. For example, user 2232 sees a bottom perspective of the birds.

The server 2204 or the virtual window 2236 can composite the video clip of the object into the second view 2240 for displaying on the second virtual window 2236. For example, the skylight virtual window 2236 shows clouds, rain, etc. In some examples, the virtual windows 2248, 2236 synchronize together, both showing rain or snow. In some examples, a bird flies across the virtual window 2236 and appears to continue its journey across the virtual window 2248.

The motion of the object across the second view 2240 is timed (either to occur before or after) relative to motion of the object across the first view 2252. In some embodiments, the server 2204 composites the video clip of the object into the second view 2240 for displaying on the second virtual window 2236. The server 2204 transmits the composited second view 2240 (including the video clip of the object) to the second virtual window 2236 for displaying on the second virtual window 2236. In some embodiments, the virtual window 2236 composites the video clip of the object into the second view 2240 after downloading the second view 2240 (without the video clip) and the video clip of the object separately. The virtual windows can be programmed to turn off, or go dark, or display a night scene when it is nighttime at the location.

In some embodiments, the virtual window system running on the server 2204 or on a computer processor of the virtual window 2248 digitally adds visual effects (e.g., rain, sunlight, fog, or snow) to the views 2240, 2252 using an artificial intelligence (AI) algorithm. For example, adding the visual effects to a view and displaying the view on the electronic display are controllable by the software application. The digital weather effects can be added to reflect current weather conditions at the physical location of the virtual window 2248 based on live, online weather data, even though the actual weather at the location where the view was filmed is different. For example, a video filter is used to perform operations on a multimedia stream (the original view) using an AI model. Multiple filters can be used in a chain, known as a filter graph, in which each filter receives input from its upstream filter, processes the input, and outputs the processed video to its downstream filter. The use of AI to digitally add visual effects to a view is illustrated and described in more detail with reference to FIG. 26. In some embodiments, the virtual window system adjusts (e.g., using an AI model) a hue of a view based on a particular time at the geographical location where the view was filmed or the location where the virtual window is. For example, the quality of light in the view can be adjusted to match a time-of-day (sunrise, twilight, sunset, etc.) at the viewing location.

In some embodiments, virtual window 2248 tracks a perspective of user 2232 relative to the virtual window 2248, as described in more detail with reference to FIG. 1. The virtual window system can adjust the views 2240, 2252 based on a change in the perspective to provide a more realistic impression of actual windows. For example, if user 2232 is positioned at an angle relative to the virtual window 2248, the view is adjusted (e.g., panned, scrolled, or moved) to match the angle. The virtual window system transmits the adjusted views to the virtual windows 2236, 2248 for displaying on the virtual windows 2236, 2248.

In some embodiments, downloading video from server 2204 by the virtual windows 2236, 2248 is performed using one or more video codecs to reduce greenhouse gas emissions caused by the download. For example, one or more of the following codecs are used to compress a view, avatar, or digital effects before transmission of video from server 2204 to the virtual windows 2236, 2248: H. 265, AV1, or VVC. High Efficiency Video Coding, also known as H.265 and MPEG-H Part 2, is a video compression standard designed as part of the MPEG-H project as a successor to the widely used Advanced Video Coding. AOMedia Video 1 (AV1) is an open video coding format initially designed for video transmissions over the Internet. Versatile Video Coding (VVC), also known as H.266, ISO/IEC 23090-3, and MPEG-I Part 3, is a video compression standard that can also be used to implement the embodiments disclosed herein.

As described herein, transferring 1 GB of data can generally produce approximately 3 kg of CO2. Each GB of data downloaded thus results in approximately 3 kg of CO2 emissions or other greenhouse gas emissions. The storage of 100 GB of data in the cloud every year produces approximately 0.2 tons of CO2 or other greenhouse gas emissions. The video codecs for video compression implemented herein reduce the amount of data transported and stored compared to traditional methods for data transfer. The implementations disclosed herein for operating the virtual windows and the virtual window system can mitigate climate change by reducing and/or preventing additional greenhouse gas emissions into the atmosphere.

In some implementations, the virtual window embodiments described herein adapt and protect infrastructure and its operation as part of architectural structural elements or technologies for improving thermal insulation, roof garden systems, roof coverings with high solar reflectance, and planning or developing urban green infrastructure.

The video codec(s) used can be implemented in software and/or hardware that compresses and/or decompresses digital video. The virtual window system accounts for the video quality, the amount of data used to represent video (determined by the bit rate), the complexity of the encoding and decoding algorithms, sensitivity to data losses and errors, ease of editing, random access, and/or end-to-end delay (latency) when compressing, transferring, and decompressing the views. Significant increases in efficiency are achieved since the video clips generated are in a range from 4 to 20 seconds. Such files are more efficient to transmit to a virtual window because of their relatively smaller size. Using the disclosed methods, an entire view can be downloaded to a client virtual window system having onboard storage. The data transfer and storage methods disclosed herein reduce the amount of data transported and stored and obviate the need for wasteful CO2 emissions. Moreover, video codecs designed for higher resolution, lower framerate, and more efficient video event (clip) insertion are used. Therefore, the disclosed implementations mitigate climate change and the effects of climate change by reducing the amount of data stored and downloaded in comparison to conventional technologies.

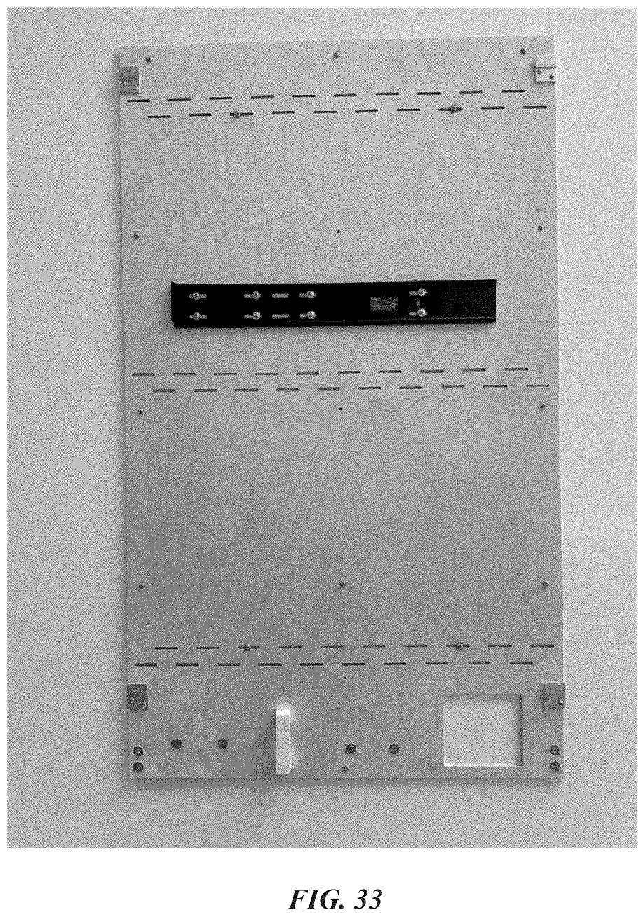

In some implementations, a virtual window is located at a particular location (e.g., the location of building 2264). The virtual window includes an electronic display (e.g., electronic display 3016 shown by FIG. 30). The electronic display is configured to be mounted on (as shown by FIG. 33) or embedded in (as shown by FIG. 16) a surface (e.g., ceiling 2244 or wall 2268) of building 2264, which can be an office, a hotel, a home, etc. The virtual window includes a layer of tempered glass (e.g., layer 3008 shown by FIG. 30). The layer of tempered glass is configured to protect the electronic display and provide reflections of light on the glass to provide a realistic impression of an actual window at the particular location to the user.

The virtual window includes a computer system communicably coupled to the electronic display. The computer system is configured to store a view (e.g., view 2252) downloaded from a computer server (e.g., server 2204). The virtual window can be controlled by a user device 2228 and can connect to a local network 2220 (e.g., Wi-Fi). The computer server can composite an image or a video clip (e.g., of an unexpected event) into the view at a particular time. The image or video clip can be downloaded from the server. The virtual window can digitally add visual effects (e.g., rain or snow) to the view, using an artificial intelligence algorithm, based on data describing weather at the particular location. The view (e.g., lengths of different scenes or portions of the view) is manipulated (shortened or lengthened) based on sunrise and sunset times at the particular location to provide a realistic impression of an actual window installed at the particular location.

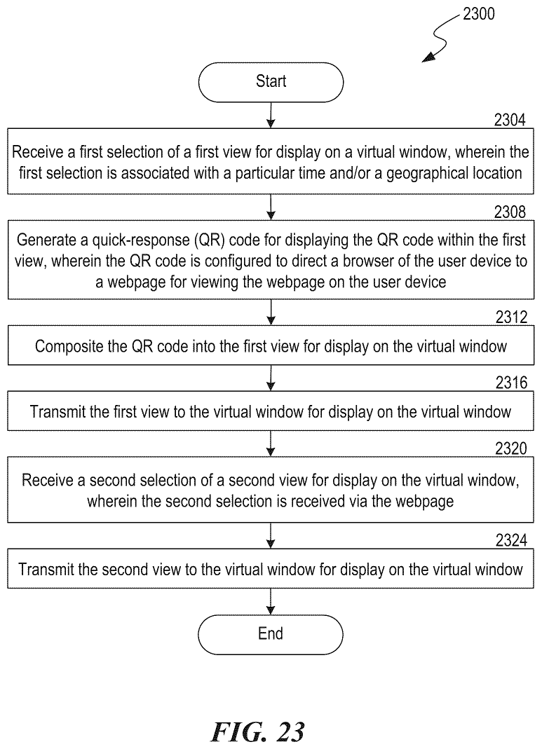

FIG. 23 illustrates an example process for operating a virtual window system, in accordance with one or more embodiments. In some implementations, process 2300 is performed by a virtual window system implemented on computer server 2204 illustrated and described in more detail with reference to FIG. 22. In some implementations, the process is performed by a computer system, e.g., the example computer system 2700 illustrated and described in more detail with reference to FIG. 27. Particular entities, for example, virtual windows 2236, 2248 or user device 2228 (shown by FIG. 22) perform some or all of the steps of process 2300 in other implementations. Likewise, implementations can include different and/or additional steps or can perform the steps in different orders.

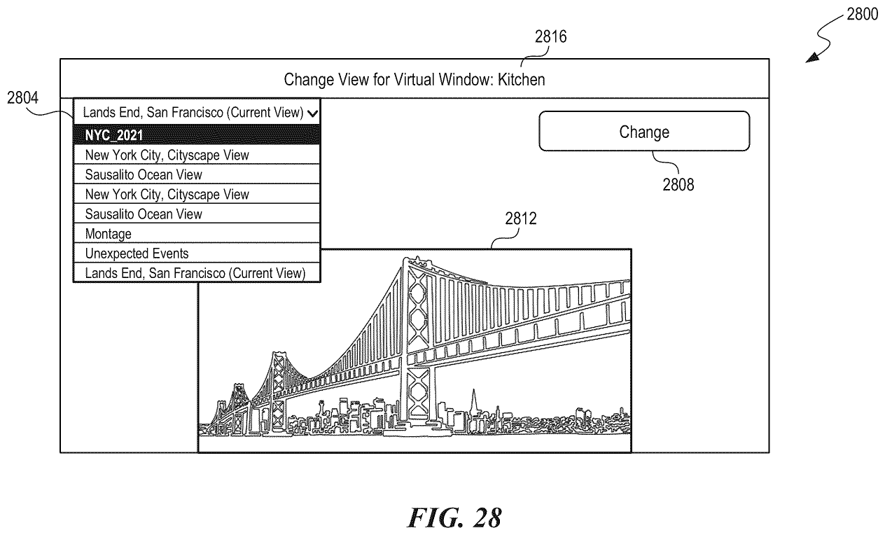

At 2304, a computer system (for example, server 2204 shown by FIG. 22) receives a first selection (e.g., selection 2804 shown by FIG. 28) of a first view for displaying on a virtual window (e.g., virtual window 2248). The first selection can be received from a user device (e.g., user device 2228) that is remote to the computer system and proximate to the virtual window. The first selection is associated with a particular time and/or a geographical location. For example, as shown by FIG. 29B, the selection of the view 2944 is associated with time 9:40 PM to time 8:00 AM at the location, Monterey Bay. Hence a view depicting Monterey Bay from 9:40 PM to 8:00 AM (local time at Monterey Bay) can be displayed on the virtual window.

At 2308, the computer system generates a quick-response (QR) code (e.g., QR code 2260) for displaying the QR code within the first view. The QR code can be shaped, sized, and colored, based on the shapes of images and background colors present in the first view, to blend into a background of the first view. In some implementations, a color of the QR code is changed as the background of the first view changes, such that the QR code doesn't stick out in the first view. In some examples, the first view is of Sausalito, CA, and the QR code is colored a shade of blue, similar to the color of the water being displayed in the first view. In some examples, the QR code is physically over the water, blending into the shot a little but far from invisible. This is more aesthetically pleasing than if the QR code or visual cue to a URL was bright red, contrasting dramatically with the background and disturbing the visual composition. The hidden nature of the QR code can also spark curiosity by a user viewing the first view.

The QR code is configured to display a universal resource locator (URL) on a user device, wherein a web page associated with the URL is configured to enable a selection, by a user, of another view for displaying on the virtual window. For example, the QR code is configured to direct a browser of the user device (via a camera of the user device) to a web page or URL for viewing the web page or URL on the user device. In some examples, a QR code and/or a visual cue is configured to appear on the virtual window and is designed to blend into the background. The QR code directs a browser of the user device to a web page. The web page can include advertisements and/or a menu to change views from a library (e.g., library 2912 shown by FIG. 29A) stored on server 2204 or downloaded to the virtual window. For instance, the virtual window is in a hotel lobby, where the web page displays a discount at a restaurant on the property, or the web page has a menu enabling the user to change the view displayed on the virtual window from Miami to Hawaii. In some examples, a QR code is presented on a virtual window in a hotel room to personalize the virtual window. When a customer comes into a hotel room, they can interact with a virtual window there that has a personalization message displayed. For instance, a guest enters a hotel room and views a virtual window that displays, “Welcome, Jim, to the Clarendon Hotel. To pick a view, <instructions/QR code>.”

At 2312, in some embodiments, the computer system composites the QR code into the first view for displaying on the virtual window. In some embodiments, the first view is downloaded by the virtual window before the QR code is generated. In such embodiments, after the QR code is generated by the computer system, the QR code is downloaded by the virtual window and composited into the downloaded view.

At 2316, in some embodiments, the computer system transmits the first view (including the QR code) to the virtual window for displaying on the virtual window. The virtual window displays the composited first view.

At 2320, the computer system receives a second selection of a second view for displaying on the virtual window. For example, a user device scans the QR code in the first view, and the user device is directed to a web page displaying a user interface (e.g., user interface 2800 shown by FIG. 28) having a control menu. The user selects a second view (e.g., view 2812) on user interface 2800 using menu option 2808. The second selection is received via the web page displaying the user interface.

At 2324, responsive to receiving the second selection, in some embodiments, the computer system transmits the second view to the virtual window for displaying on the virtual window. In some embodiments, the second view is previously downloaded to the virtual window. In such embodiments, the virtual window switches the display to the previously downloaded second view. In some implementations, the first view depicts the geographical location, and the second view includes an image or a pre-recorded video stored on the computer system. For example, the virtual window can be switched using the web page to show other content. For instance, in a dentist's office, the virtual window can be used for the therapeutic benefits of the views themselves and then changed to show X-rays or a treatment plan.

In some implementations, at least one of the first view or the second view includes a live video feed streamed from the computer system to the virtual window. For example, instead of pre-recording a 24-hour video and downloading it to the virtual window before displaying the view, a camera set up at the geographical location can stream live video to the virtual window. In some examples, the computer system (e.g., server 2204) can stream a stored video (view) to the virtual window.

In some embodiments, the virtual window system generates an image or video clip of a photorealistic object or animated object. Example objects are shown by FIG. 7 and FIG. 10A. The image or video clip of the photorealistic object or animated object is generated for compositing the image or video clip into a view. At least one feature of the photorealistic object or animated object is associated with the particular time and/or the geographical location. For example, if the location is a beach in Hawaii and the time is late afternoon, a realistic video clip of seagulls flying over the beach is generated. In some embodiments, the computer system composites the image or video clip into the view and transmits the composited view to a virtual window. In some embodiments, the virtual window has already downloaded the view (without the image or video clip). In such embodiments, the computer system reduces the amount of data transferred by transmitting the image or video clip to the virtual window for compositing into the view for displaying on the virtual window.

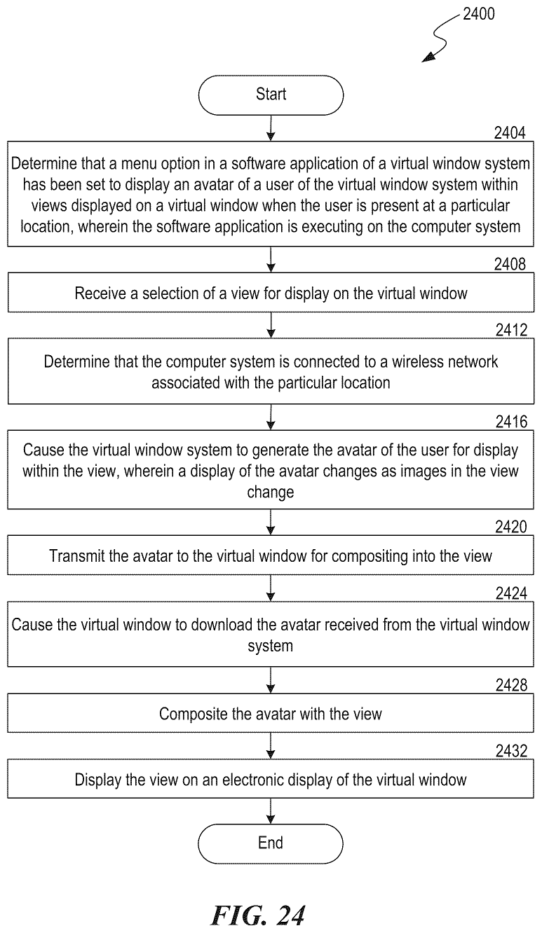

FIG. 24 illustrates an example process for operating a virtual window, in accordance with one or more embodiments. In some implementations, process 2400 is performed by a virtual window system implemented on computer server 2204 illustrated and described in more detail with reference to FIG. 22. In some implementations, the process is performed by a computer system, e.g., the example computer system 2700 illustrated and described in more detail with reference to FIG. 27. Particular entities, for example, virtual windows 2236, 2248 or user device 2228 (see FIG. 22), perform some or all of the steps of process 2400 in other implementations. Likewise, implementations can include different and/or additional steps or can perform the steps in different orders.

At 2404, a computer system (e.g., user device 2228 shown by FIG. 22) determines that a menu option in a software application (e.g., the applications shown by FIGS. 29A, 29B) of a virtual window system has been set to display an avatar (e.g., avatar 2256) of a user (e.g., user 2232) of the virtual window system within views (e.g., view 2252) displayed on a virtual window (e.g., virtual window 2248) when the user is present at a particular location (e.g., the location of building 2264). The software application is executed on the computer system (e.g., a tablet or smartphone).

At 2408, the computer system receives a selection (e.g., selection 2804 shown by FIG. 28) of a view for displaying on the virtual window. The view is selectable on the computer system from among multiple views, as shown by FIGS. 28 and 29A. The multiple views can be a library (e.g., library 2912 shown by FIG. 29A) of 24-hour videos filmed at different locations and downloaded to the virtual window. For example, the user selects view 2812 on user interface 2800 using a menu option 2808, as shown by FIG. 28. The location 2816 of the virtual window in the building can also be selected. The computer system can cause the selected view (without the avatar) to be displayed on the virtual window.

At 2412, the computer system determines that it is connected to a wireless network (e.g., network 2220 shown by FIG. 22) associated with the particular location, indicating that the user is present at the particular location. In some embodiments, the computer system receives a service set identifier (SSID), a Wi-Fi network name, a list of Wi-Fi networks, network configuration data, and/or network settings from the wireless network (e.g., within data 2224) based on which the computer system determines that it is connected to the wireless network associated with the particular location (e.g., a home Wi-Fi network or office Wi-Fi network). In some examples, the computer system uses the actual locations of the user device and the virtual window. In some examples, the computer system uses the latitude and longitude of the user device to determine presence.

At 2416, responsive to determining that the computer system is connected to the wireless network, the computer system can cause the virtual window system to generate the avatar of the user for displaying within the view. A display of the avatar changes as images in the view change. For example, the virtual window system uses an installed app on the user's smartphone or tablet and recognizes when a user is on their home/local Wi-Fi network. When a user is on a home/local network and the user selects a specific setting on the app, the avatar will appear in the view, representing the user. For instance, when a user enters their home and a water view has been chosen, a small red boat may appear occasionally. When another member of the same household has the app, is recognized on the same home/local Wi-Fi network, and has chosen the specific setting to include an avatar, their (different) avatar will appear as well. In this case, for example, it could be a seaplane that occasionally crosses the view.

At 2420, in some embodiments, the computer system can transmit the avatar to the virtual window for compositing into the view. In some embodiments, the compositing is performed on server 2204 (shown by FIG. 22) and the composited view and avatar are downloaded by the virtual window. Compositing refers to combining visual elements, images, and video clips from separate sources into single images or videos to create the illusion that all those elements are parts of the same view.

At 2424, in some embodiments, the computer system causes the virtual window to download the avatar received from the virtual window system. For example, the virtual window 2248 (shown by FIG. 22) downloads avatar 2256 within data 2216 from server 2204 over network 2212. In some embodiments, the virtual window downloads an entire composited view, including the avatar, for displaying. At 2428, in some embodiments, the computer system causes the virtual window to composite the avatar into the view for displaying on the virtual window. At 2432, the computer system causes the virtual window to display the view having the avatar on an electronic display of the virtual window.

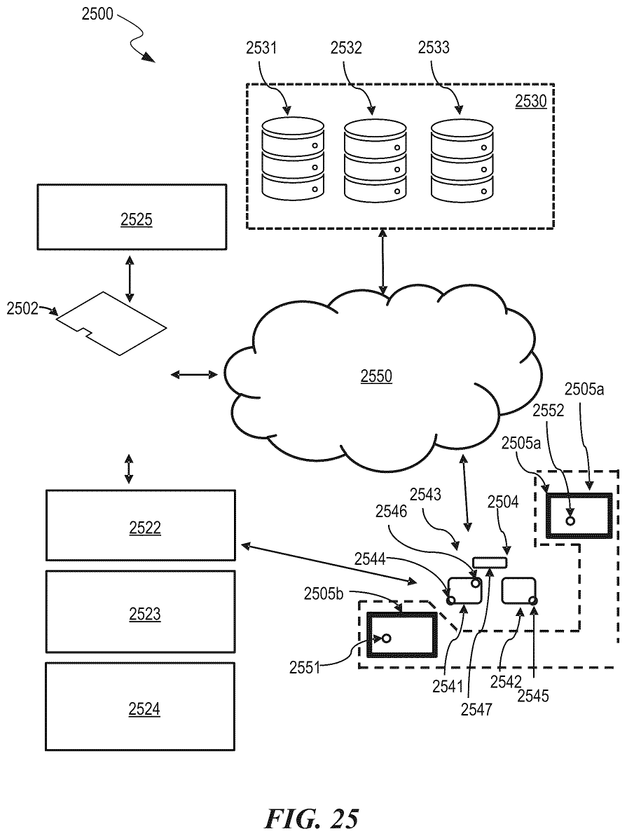

FIG. 25 illustrates an extended-reality (XR) system 2500 that can be used with virtual windows 2505, in accordance with one or more embodiments. Extended reality is a catch-all term used to refer to augmented reality, virtual reality, and mixed reality. The technology is intended to combine or mirror the physical world with a “digital twin world” that is able to interact with each other. A digital twin can be displayed on a virtual window 2505a. System 2500 can be used in conjunction with communicably coupling (e.g., via a communication channel) a virtual window 2505b to a camera/server, receiving a video from the camera, etc.

System 2500 can be used to extract a feature vector from data, such as a view, for altering the view. For example, digital rain images can be composited into the view. System 2500 can analyze views, images, graphics, or video and then generate additional content for displaying on a virtual window 2505a. System 2500 can remove, add, or modify portions of video based on, for example, system performance, user input, predicted events, or the like. System 2500 can generate an XR environment (e.g., an augmented reality (AR) environment or other environment) with displayed event information (e.g., mappings of moving objects), sensor data, user data (e.g., real-time behavior), and other information for assisting the user.

System 2500 can also include an AR device (e.g., wearable device 2504) that provides virtual reality (VR) simulations or other changing information. The configuration of the wearable device 2504, information displayed, and feedback provided to the user can be selected. System 2500 includes a server (or other computer system 2502), where such system 2502 includes one or more non-transitory storage media storing program instructions to perform one or more operations of a projection module 2522, a display module 2523, or a feedback module 2524. In some embodiments, system 2500 includes wearable device 2504, where the wearable device 2504 may include one or more non-transitory storage media storing program instructions to perform one or more operations of the projection module 2522, the display module 2523, or the feedback module 2524.

System 2500 can include one or more wearable devices configured to be worn on other parts of the body. The wearable devices can include, for example, gloves (e.g., haptic feedback gloves or motion-tracking gloves), wearable glasses, loops, heart monitors, heart rate monitors, or the like. These wearable devices can communicate with a virtual window 2505b or with components of the system 2500 via wire connections, optical connections, wireless communications, etc. Virtual windows 2505 are provided instructions to display visual stimuli based on measurements or instructions provided by the wearable device 2504 or the server 2502. In some embodiments, the wearable device 2504 may communicate with various other electronic devices via a network 2550, where the network 2550 may include the Internet, a local area network, a peer-to-peer network, etc. The wearable device 2504 may send and receive messages through the network 2550 to communicate with a server 2502, where the server 2502 may include one or more non-transitory storage media storing program instructions to perform one or more operations of a statistical predictor 2525. Operations described in this disclosure as being performed by the server 2502 may instead be performed by virtual windows 2505 or the wearable device 2504, where program code or data stored on the server 2502 may be stored on the wearable device 2504 or another client computer device instead.

The wearable device 2504 can include a case 2543, a left transparent display 2541, and a right transparent display 2542, where light may be projected from emitters of the wearable device through waveguides of the transparent displays 2541-2542 to present stimuli viewable by an eye(s) of a user wearing the wearable device 2504. The wearable device 2504 also includes a set of outward-facing sensors 2547, where the set of outward-facing sensors 2547 may provide sensor data indicating the physical space around the wearable device 2504. In some embodiments, the sensors 2547 can be cameras that capture images/video of the environment, people, equipment, user, or the like. Output from the sensors 2547 of the wearable device 2504 can be used to analyze the concentration/focus level of the user, alertness of the user, stress level of the user (e.g., stress level calculated based on user metrics, such as heart rate, blood pressure, or breathing pattern), and other metrics.

In some implementations, a perspective of a user relative to a virtual window is tracked, and a view is adjusted based on a change in the perspective. For example, sensors 2547 can track the wearer's eyes. Furthermore, the system 2500 may present stimuli on virtual windows 2505 during a visual testing operation. For example, some embodiments may use the wearable device 2504 to collect feedback information that includes various eye-related characteristics. In some embodiments, the feedback information may include an indication of a response of an eye to the presentation of a dynamic stimulus at a display location 2546 on a wearable device 2504.

In some embodiments, data used or updated by one or more operations described in this disclosure may be stored in a set of databases 2530. In some embodiments, the server 2502, the wearable device 2504, the virtual windows 2505, or other computer devices may access the set of databases to perform one or more operations described in this disclosure. For example, a prediction model used to determine ocular information may be obtained from a first database 2531, where the first database 2531 may be used to store prediction models or parameters of prediction models. Alternatively, or in addition, the set of databases 2530 may store feedback information collected by the wearable device 2504 or results determined from the feedback information. For example, a second database 2532 may be used to store a set of user profiles that include or link to feedback information corresponding with eye measurement data for the users identified by the set of user profiles. Alternatively, or in addition, the set of databases 2530 may store instructions indicating different types of testing procedures. For example, a third database 2533 may store a set of testing instructions that causes a stimulus to be presented on the wearable device 2504, then causes a stimulus to be presented on the virtual window 2505a, and thereafter causes a third stimulus to be presented on the virtual window 2505b.

In some embodiments, the projection module 2522 may generate a field-to-display map that maps a position or region of a visual field with a position or region of the virtual windows 2505. The projection module 2522 can obtain sensor information from the set of outward-facing sensors 2547, where the sensor information may include position measurements of the virtual windows 2505. In some implementations, a view is generated in accordance with an orientation of a virtual window and/or a spatial relationship between two virtual windows. For example, a user wearing the wearable device 2504 may rotate or translate their head, which may cause a corresponding rotation or translation of the wearable device 2504. Some embodiments may detect these changes in the physical orientation or position of the wearable device 2504 with respect to the virtual windows 2505. Some embodiments may then perform a mapping operation to determine the positions and orientations of the virtual windows 2505 based on the sensor information collected by the set of outward-facing sensors 2547.

In some embodiments, the projection module 2522 may update a field-to-display map that stores or otherwise indicates associations between field locations of a visual field and display locations 2551, 2552 of the virtual windows 2505. For example, the set of outward-facing sensors 2547 may include one or more cameras to collect visual information from a surrounding area of the wearable device 2504, where the visual information may be used to determine a position or orientation of one or more devices of the virtual windows 2505. As the wearable device 2504 is moved, some embodiments may continuously obtain sensor information indicating changes to the external environment, including changes in the position or orientation of the virtual windows 2505 relative to the position or orientation of the wearable device 2504. For example, some embodiments may generate a point cloud representing the surfaces of objects around the wearable device 2504 and determine the positions and orientations of the virtual windows 2505 relative to the wearable device 2504 based on the point cloud.

In some embodiments, the display module 2523 presents a set of stimuli on the virtual windows 2505. Some embodiments may determine the display location for a stimulus by determining the location or region of a visual field. After determining the location or region of the visual field, some embodiments may then use a field-to-display map to determine which display location of the virtual windows 2505 to use for displaying. For example, a field-to-display map is used to determine a display location 2551 on the virtual window 2505b and, in response to selecting the display location 2551, display a stimulus at the display location 2551. The field-to-display map can determine a display location 2552 on the virtual window 2505a and, in response to selecting the display location 2552, display a stimulus at the display location 2552. As described elsewhere in this disclosure, some embodiments may measure eye movements or otherwise measure responses of an eye to the stimuli presented on the virtual windows 2505 to measure a visual field of the eye.

In some embodiments, the feedback module 2524 may record feedback information indicating eye responses to the set of stimuli presented on the virtual windows 2505. In some embodiments, the transparent displays 2541-2542 may include a left inward-directed sensor 2544 and a right inward-directed sensor 2545, where the inward-directed sensors 2544-2545 may include eye-tracking sensors. The inward-directed sensors 2544-2545 may include cameras, infrared cameras, photodetectors, infrared sensors, etc. For example, the inward-directed sensors 2544-2545 may include cameras configured to track pupil movement and determine and track the visual axes of the subject. By collecting feedback information while stimuli are presented on the virtual windows 2505, some embodiments may increase the boundaries of a visual field for which ocular data may be detected. In some embodiments, the statistical predictor 2525 may retrieve stimuli information, such as stimuli locations and characteristics of the stimuli locations, where the stimuli locations may include locations on the virtual windows 2505.

FIG. 26 is a block diagram illustrating an example artificial intelligence (AI) system 2600, in accordance with one or more embodiments. The AI system 2600 is implemented using components of the example computer system 2700 illustrated and described in more detail with reference to FIG. 27. For example, the AI system 2600 can be implemented using the processor 2702 and instructions 2708 programmed in the memory 2706 illustrated and described in more detail with reference to FIG. 27. Likewise, implementations of the AI system 2600 can include different and/or additional components or be connected in different ways.

As shown, the AI system 2600 can include a set of layers, which conceptually organize elements within an example network topology for the AI system's architecture to implement a particular AI model 2630. Generally, an AI model 2630 is a computer-executable program implemented by the AI system 2600 that analyzes data to make predictions. Information can pass through each layer of the AI system 2600 to generate outputs for the AI model 2630. The layers can include a data layer 2602, a structure layer 2604, a model layer 2606, and an application layer 2608. The algorithm 2616 of the structure layer 2604 and the model structure 2620 and model parameters 2622 of the model layer 2606 together form the example AI model 2630. The optimizer 2626, loss function engine 2624, and regularization engine 2628 work to refine and optimize the AI model 2630, and the data layer 2602 provides resources and support for application of the AI model 2630 by the application layer 2608.

The data layer 2602 acts as the foundation of the AI system 2600 by preparing data for the AI model 2630. As shown, the data layer 2602 can include two sub-layers: a hardware platform 2610 and one or more software libraries 2612. The hardware platform 2610 can be designed to perform operations for the AI model 2630 and include computing resources for storage, memory, logic, and networking, such as the resources described in relation to FIG. 12. The hardware platform 2610 can process amounts of data using one or more servers. The servers can perform backend operations such as matrix calculations, parallel calculations, machine learning (ML) training, and the like. Examples of servers used by the hardware platform 2610 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 2610 can include Infrastructure as a Service (IaaS) resources, which are computing resources (e.g., servers, memory, etc.) offered by a cloud services provider. The hardware platform 2610 can also include computer memory for storing data about the AI model 2630, application of the AI model 2630, and training data for the AI model 2630. The computer memory can be a form of random-access memory (RAM), such as dynamic RAM, static RAM, and non-volatile RAM.

The software libraries 2612 can be thought of as suites of data and programming code, including executables, used to control the computing resources of the hardware platform 2610. The programming code can include low-level primitives (e.g., fundamental language elements) that form the foundation of one or more low-level programming languages such that servers of the hardware platform 2610 can use the low-level primitives to carry out specific operations. The low-level programming languages do not require much, if any, abstraction from a computing resource's instruction set architecture, allowing them to run quickly with a small memory footprint. Examples of software libraries 2612 that can be included in the AI system 2600 include Intel Math Kernel Library, Nvidia cuDNN, Eigen, and Open BLAS.

The structure layer 2604 can include a machine learning (ML) framework 2614 and an algorithm 2616. The ML framework 2614 can be thought of as an interface, library, or tool that allows users to build and deploy the AI model 2630. The ML framework 2614 can include an open-source library, an application programming interface (API), a gradient-boosting library, an ensemble method, and/or a deep learning toolkit that work with the layers of the AI system to facilitate development of the AI model 2630. For example, the ML framework 2614 can distribute processes for application or training of the AI model 2630 across multiple resources in the hardware platform 2610. The ML framework 2614 can also include a set of pre-built components that have the functionality to implement and train the AI model 2630 and allow users to use pre-built functions and classes to construct and train the AI model 2630. Thus, the ML framework 2614 can be used to facilitate data engineering, development, hyperparameter tuning, testing, and training for the AI model 2630.

Examples of ML frameworks 2614 or libraries that can be used in the AI system 2600 include TensorFlow, PyTorch, scikit-learn, Keras, and Caffe. Random Forest is a machine learning algorithm that can be used within the ML frameworks 2614. LightGBM is a gradient-boosting framework/algorithm (an ML technique) that can be used. Other techniques/algorithms that can be used are XGBoost, CatBoost, etc. Amazon Web Services is a cloud service provider that offers various machine learning services and tools (e.g., Sage Maker) that can be used for platform building, training, and deploying ML models.

In some embodiments, the ML framework 2614 performs deep learning (also known as deep structured learning or hierarchical learning) directly on the input data to learn data representations, as opposed to using task-specific algorithms. In deep learning, no explicit feature extraction is performed; the features of feature vector are implicitly extracted by the AI system 2600. For example, the ML framework 2614 can use a cascade of multiple layers of nonlinear processing units for implicit feature extraction and transformation. Each successive layer uses the output from the previous layer as input. The AI model 2630 can thus learn in supervised (e.g., classification) and/or unsupervised (e.g., pattern analysis) modes. The AI model 2630 can learn multiple levels of representations that correspond to different levels of abstraction, wherein the different levels form a hierarchy of concepts. In this manner, AI model 2630 can be configured to differentiate features of interest from background features.

The algorithm 2616 can be an organized set of computer-executable operations used to generate output data from a set of input data and can be described using pseudocode. The algorithm 2616 can include complex code that allows the computing resources to learn from new input data and create new/modified outputs based on what was learned. In some implementations, the algorithm 2616 can build the AI model 2630 through being trained while running computing resources of the hardware platform 2610. This training allows the algorithm 2616 to make predictions or decisions without being explicitly programmed to do so. Once trained, the algorithm 2616 can run at the computing resources as part of the AI model 2630 to make predictions or decisions, improve computing resource performance, or perform tasks. The algorithm 2616 can be trained using supervised learning, unsupervised learning, semi-supervised learning, and/or reinforcement learning.

Using supervised learning, the algorithm 2616 can be trained to learn patterns (e.g., light in a view changing from high noon to twilight) based on labeled training data. The training data may be labeled by an external user or operator. For instance, a user may collect a set of training data, such as by capturing data from sensors, images from a camera, outputs from a model, and the like. In an example implementation, training data can include video clips of rain, snow, and fog from a library or a palette of hues. The user may label the training data based on one or more classes and train the AI model 2630 by inputting the training data to the algorithm 2616. The algorithm determines how to label the new data based on the labeled training data. The user can facilitate collection, labeling, and/or input via the ML framework 2614. In some instances, the user may convert the training data to a set of feature vectors for input to the algorithm 2616. Once trained, the user can test the algorithm 2616 on new data to determine if the algorithm 2616 is predicting accurate labels for the new data. For example, the user can use cross-validation methods to test the accuracy of the algorithm 2616 and retrain the algorithm 2616 on new training data if the results of the cross-validation are below an accuracy threshold.

Supervised learning can involve classification and/or regression. Classification techniques involve teaching the algorithm 2616 to identify a category of new observations based on training data and are used when input data for the algorithm 2616 is discrete. Said differently, when learning through classification techniques, the algorithm 2616 receives training data labeled with categories (e.g., seasons or times-of-day) and determines how features observed in the training data (e.g., shadows) relate to the categories (e.g., hues of the sky). Once trained, the algorithm 2616 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 2616 is continuous. Regression techniques can be used to train the algorithm 2616 to predict or forecast relationships between variables. To train the algorithm 2616 using regression techniques, a user can select a regression method for estimating the parameters of the model. The user collects and labels training data that is input to the algorithm 2616 such that the algorithm 2616 is trained to understand the relationship between data features and the dependent variable(s). Once trained, the algorithm 2616 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for machine learning-based pre-processing operations.

Under unsupervised learning, the algorithm 2616 learns patterns from unlabeled training data. In particular, the algorithm 2616 is trained to learn hidden patterns and insights of input data, which can be used for data exploration or for generating new data. Here, the algorithm 2616 does not have a predefined output, unlike the labels output when the algorithm 2616 is trained using supervised learning. Another way unsupervised learning is used to train the algorithm 2616 to find an underlying structure of a set of data is to group the data according to similarities and represent that set of data in a compressed format. The virtual window system disclosed herein can use unsupervised learning to identify patterns in data (e.g., pixel color values) and so forth. In some implementations, performance of the virtual window system using unsupervised learning is improved by improving the video provided to the virtual windows, as described herein.

A few techniques can be used in supervised learning: clustering, anomaly detection, and techniques for learning latent variable models. Clustering techniques involve grouping data into different clusters that include similar data such that other clusters contain dissimilar data. For example, during clustering, data with possible similarities remain in a group that has less or no similarities to another group. Examples of clustering techniques include density-based methods, hierarchical-based methods, partitioning methods, and grid-based methods. In one example, the algorithm 2616 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 2616 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 2616 include factor analysis, item response theory, latent profile analysis, and latent class analysis.

In some embodiments, the AI system 2600 trains the algorithm 2616 of AI model 2630, based on the training data, to correlate the feature vector to expected outputs in the training data. As part of the training of the AI model 2630, the AI system 2600 forms a training set of features and training labels by identifying a positive training set of features that have been determined to have a desired property in question and, in some embodiments, forms a negative training set of features that lack the property in question. The AI system 2600 applies ML framework 2614 to train the AI model 2630, which, when applied to the feature vector, outputs indications of whether the feature vector has an associated desired property or properties, such as a probability that the feature vector has a particular Boolean property, or an estimated value of a scalar property. The AI system 2600 can further apply dimensionality reduction (e.g., via linear discriminant analysis (LDA), PCA, or the like) to reduce the amount of data in the feature vector to a smaller, more representative set of data.

The model layer 2606 implements the AI model 2630 using data from the data layer and the algorithm 2616 and ML framework 2614 from the structure layer 2604, thus enabling decision-making capabilities of the AI system 2600. The model layer 2606 includes a model structure 2620, model parameters 2622, a loss function engine 2624, an optimizer 2626, and a regularization engine 2628.

The model structure 2620 describes the architecture of the AI model 2630 of the AI system 2600. The model structure 2620 defines the complexity of the pattern/relationship that the AI model 2630 expresses. Examples of structures that can be used as the model structure 2620 include decision trees, support vector machines, regression analyses, Bayesian networks, Gaussian processes, genetic algorithms, and artificial neural networks (or, simply, neural networks). The model structure 2620 can include a number of structure layers, a number of nodes (or neurons) at each structure layer, and activation functions of each node. Each node's activation function defines how the node converts data received to data output. The structure layers may include an input layer of nodes that receive input data and an output layer of nodes that produce output data. The model structure 2620 may include one or more hidden layers of nodes between the input and output layers. The model structure 2620 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoders, and Generative Adversarial Networks (GANs).

The model parameters 2622 represent the relationships learned during training and can be used to make predictions and decisions based on input data. The model parameters 2622 can weight and bias the nodes and connections of the model structure 2620. For instance, when the model structure 2620 is a neural network, the model parameters 2622 can weight and bias the nodes in each layer of the neural networks such that the weights determine the strength of the nodes and the biases determine the thresholds for the activation functions of each node. The model parameters 2622, in conjunction with the activation functions of the nodes, determine how input data is transformed into desired outputs. The model parameters 2622 can be determined and/or altered during training of the algorithm 2616.

The loss function engine 2624 can determine a loss function, which is a metric used to evaluate the AI model's 2630 performance during training. For instance, the loss function engine 2624 can measure the difference between a predicted output of the AI model 2630 and the actual output of the AI model 2630 and is used to guide optimization of the AI model 2630 during training to minimize the loss function. The loss function may be presented via the ML framework 2614 such that a user can determine whether to retrain or otherwise alter the algorithm 2616 if the loss function is over a threshold. In some instances, the algorithm 2616 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 2626 adjusts the model parameters 2622 to minimize the loss function during training of the algorithm 2616. In other words, the optimizer 2626 uses the loss function generated by the loss function engine 2624 as a guide to determine what model parameters lead to the most accurate AI model 2630. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 2626 used may be determined based on the type of model structure 2620 and the size of data and the computing resources available in the data layer 2602.

The regularization engine 2628 executes regularization operations. Regularization is a technique that prevents over- and underfitting of the AI model 2630. Overfitting occurs when the algorithm 2616 is overly complex and too adapted to the training data, which can result in poor performance of the AI model 2630. Underfitting occurs when the algorithm 2616 is unable to recognize even basic patterns from the training data such that it cannot perform well on training data or on validation data. The regularization engine 2628 can apply one or more regularization techniques to fit the algorithm 2616 to the training data properly, which helps constrain the resulting AI model 2630 and improves its ability for generalized application. Examples of regularization techniques include lasso (L1) regularization, ridge (L2) regularization, and elastic (L1 and L2) regularization.

In some embodiments, the AI system 2600 can include a feature extraction module implemented using components of the example computer system 2700 illustrated and described in more detail with reference to FIG. 27. In some embodiments, the feature extraction module extracts a feature vector from input data. The feature vector includes n features (e.g., feature a, feature b, . . . , feature n). The feature extraction module reduces the redundancy in the input data, e.g., repetitive data values, to transform the input data into the reduced set of features, such as feature vector. The feature vector contains the relevant information from the input data such that events or data value thresholds of interest can be identified by the AI model 2630 by using this reduced representation. In some example embodiments, the following dimensionality reduction techniques are used by the feature extraction module: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

The application layer 2608 describes how the AI system 2600 is used to solve problems or perform tasks. In an example implementation, the application layer 2608 can include the virtual window system illustrated and described in more detail with reference to FIG. 1.

FIG. 27 is a block diagram illustrating an example computer system 2700, in accordance with one or more embodiments. Components of the example computer system 2700 can be used to implement the systems illustrated and described in more detail with reference to FIGS. 1 and 15. At least some operations described herein can be implemented on the computer system 2700.

The computer system 2700 can include one or more central processing units (“processors”) 2702, main memory 2706, non-volatile memory 2710, network adapter 2712 (e.g., network interface), video display 2718, input/output devices 2720, control device 2722 (e.g., keyboard and pointing devices), drive unit 2724 including a storage medium 2726, and a signal generation device 2730 that are communicatively connected to a bus 2716. The bus 2716 is illustrated as an abstraction that represents one or more physical buses and/or point-to-point connections that are connected by appropriate bridges, adapters, or controllers. The bus 2716, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The computer system 2700 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 2700.

While the main memory 2706, non-volatile memory 2710, and storage medium 2726 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 2728. The term “machine-readable medium” and “storage medium” shall also be taken to include any medium that is capable of storing, encoding, or carrying a set of instructions for execution by the computer system 2700.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 2704, 2708, 2728) set at various times in various memory and storage devices in a computing device. When read and executed by the one or more processors 2702, the instruction(s) cause the computer system 2700 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution. Further examples of machine-readable storage media, machine-readable media, or computer-readable media include recordable-type media such as volatile and non-volatile memory devices 2710, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 2712 enables the computer system 2700 to mediate data in a network 2714 with an entity that is external to the computer system 2700 through any communication protocol supported by the computer system 2700 and the external entity. The network adapter 2712 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 2712 can include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, as well as the circumstances under which the permission rights stand.

FIG. 28 is a drawing illustrating an example user interface 2800, in accordance with one or more embodiments. The user interface 2800 is displayed on a user device (e.g., user device 2228 shown by FIG. 22) and can be implemented using components of the example computer system 2700 shown by FIG. 27. The user interface 2800 includes a menu pulldown to receive selections (e.g., selection 2804) of views for displaying on the virtual window. Views can be selected from among multiple views, as shown by FIGS. 28 and 29A. A selected view 2812 can be previously downloaded to the virtual window or selected for download. For example, the user selects view 2812 on user interface 2800 using menu option 2808 as shown by FIG. 28. The location 2816 of the virtual window in the building can also be selected.

FIG. 29A is a drawing illustrating an example selection of multiple views on a user device 2904, in accordance with one or more embodiments. FIG. 29B is a drawing illustrating an example selection of a view 2944 on a user device, in accordance with one or more embodiments. A library 2912 of views of different locations 2908, 2916 is downloaded to a virtual window or stored on a computer system (e.g., server 2204 shown by FIG. 22) for download. In some embodiments, the computer system or user device 2904 receives a selection of multiple views depicting multiple geographical locations 2908, 2916 at a particular time 2940. For example, the user device 2904 allows users to choose unique content based on the position of the sun and time of day. A user can choose from a list of available views and decide which views to watch during sunrise or sunset. The virtual window would then play from the list of views or randomly pick from the library 2912 of views to watch a specific view from 15 minutes before sunset to 15 minutes after sunrise or sunset, giving the user the ability to watch views from around the world filmed at sunrise or sunset. Based on the selection, the virtual window is caused to display the multiple views on the virtual window in a sequence. The view 2944 displayed on a virtual window can be changed using button 2948 on the user interface shown.

FIG. 30 is a drawing illustrating an exploded view of an example virtual window 3000, in accordance with one or more embodiments. The assembly of the virtual window 3000 includes a backbox 3024, clamps 3020, an electronic display 3016, a bracket 3012, a layer of tempered glass 3008, and a removable magnetic frame 3004. The virtual window 3000 can further include one or more computer processors programmed using instructions stored in a memory, as illustrated and described in more detail with reference to FIG. 27. Likewise, embodiments of the virtual window 3000 can include different and/or additional components or be connected in different ways.

The frame 3004 and the electronic display 3016 are installed using the clamps 3020 and placed into the backbox 3024. Wiring for electronic components is installed through access points 3028a, 3028b. The frame assembly is secured to the backbox 3024 using chrome socket screws. The magnetic frame 3004 is pre-painted and installed. A perimeter casing can be installed to the backbox edge using brad nails or the equivalent. The vents 3032 are used for venting and cooling.

In some embodiments, as shown by FIG. 19 and FIG. 30, the virtual window includes a layer of tempered glass (e.g., layer 3008 shown by FIG. 30) protecting the electronic display. A computer system (e.g., user device 2228 shown by FIG. 22) can receive a selection for displaying a whiteboard on the virtual window 3000. In response to receiving the selection, the virtual window 3000 displays a single color (e.g., a white or cream background) on the virtual window 3000 for a user to write on the tempered glass layer 3008 using an erasable marker. The single color is selected to contrast with a color of the marker. The virtual window 3000 can thus be used not just as a window but as a whiteboard or a memo board. The virtual window 3000 enables a user to write directly on the tempered glass 3008 with an erasable marker while switching the content to a background of high contrast with the marker (e.g., a black marker on a white background). The virtual window 3000 can thus be used as a whiteboard.

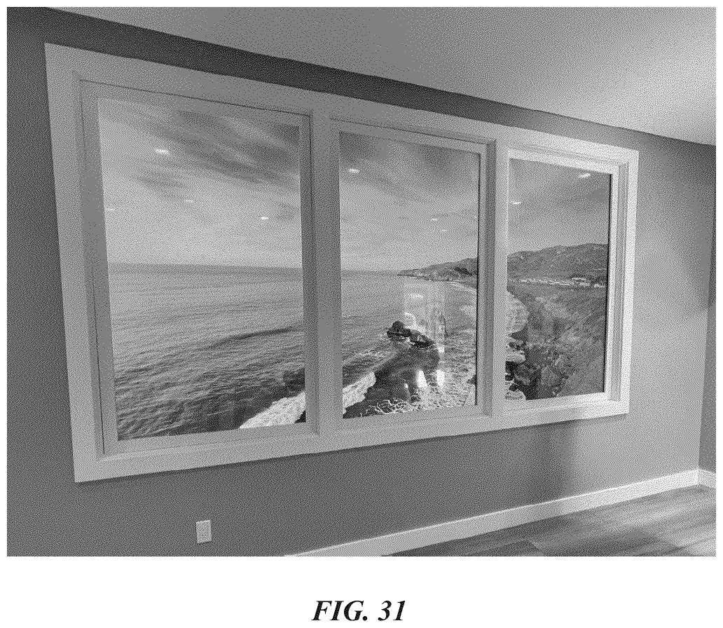

FIG. 31 shows a panoramic view presented by three virtual windows according to an embodiment.

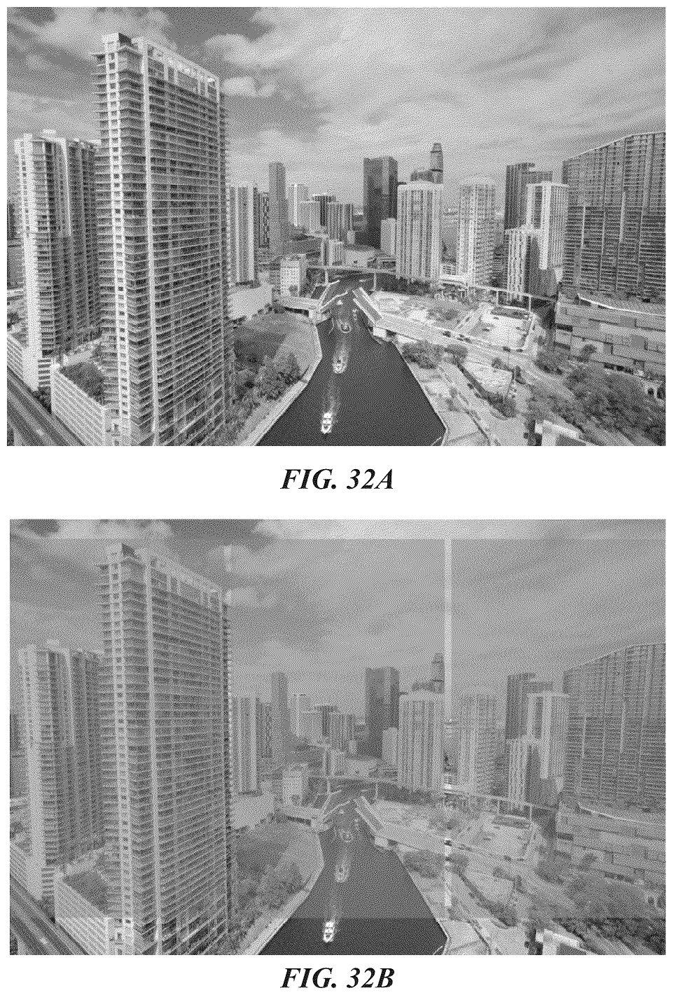

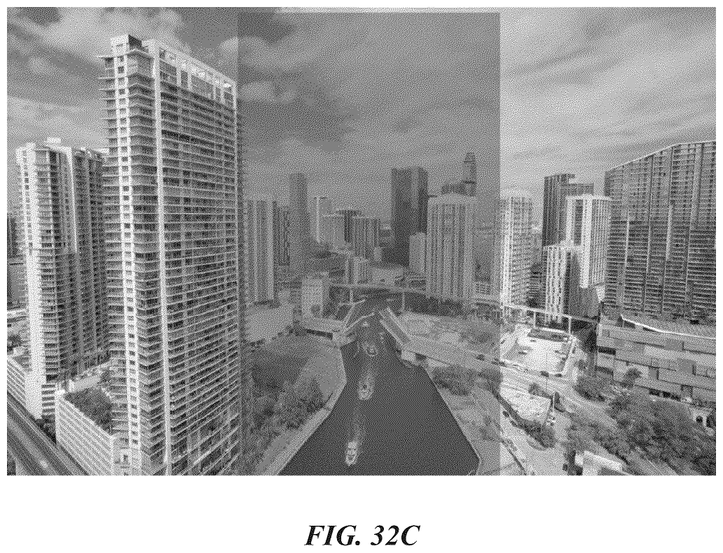

FIGS. 32A-32C show the generation of a three-screen panorama according to an embodiment in which FIG. 32A is a source view, FIG. 32B shows the source view sliced into three sections to create the illusion of reality, and FIG. 32C shows the completed three-screen panorama.

Embodiments provide a technique that allows views to be generated in high resolution such that they can be sliced into a multiple-screen, e.g., three-screen, panorama and a one-screen version. Additionally, the views are cropped in post-production; the system must account for the physical space between the displays at the installation because the embodiments use three displays that look like windows and also must account for the thickness of the window cases that create a space between each display to make the three-display view feel natural, e.g., when a bird flies across one window it has to appear that it goes behind the space between each window, covered by window trim in FIG. 31, and then reappears on the other adjoining window. To accomplish the embodiments, the system must put spaces between each slice of the image (see FIG. 32A) that match the pixel resolution of the space between windows (see FIG. 32B). If the pixel density is 70 pixels per inch, and there are 6 inches between each window, then 420 pixels must be deleted to accommodate this space and give the panoramic window a realistic effect (see FIG. 32C).

FIG. 33 shows an embodiment that provides a wall window design that hangs on the wall with a backplate to which a cleat mount is attached.

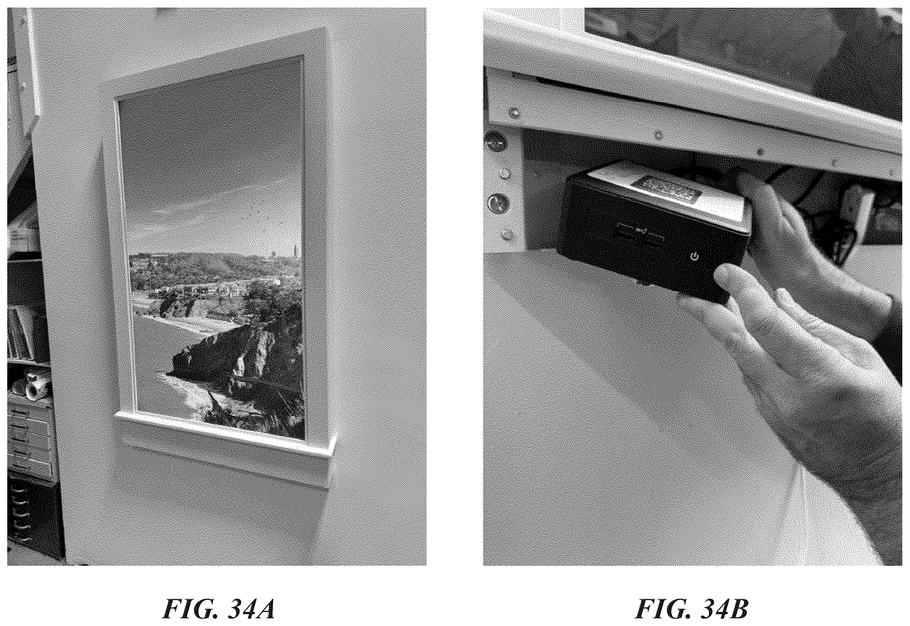

FIGS. 34A and 34B show an embodiment of an on-wall design (see FIG. 34A) in which the media player, power supplies, and plugs are placed in the windowsill (see FIG. 34B).

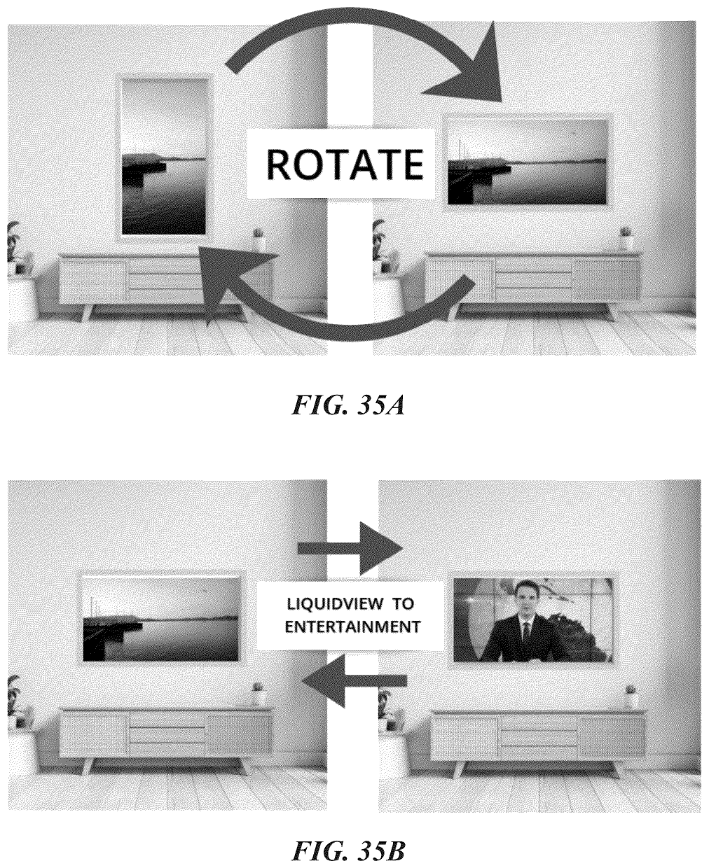

FIGS. 35A and 35B show an embodiment that displays views in a portrait orientation where the case of the virtual window is rotated 90°, after which the view changes its orientation from portrait to landscape.

In alternative embodiments, compositing an image with a video includes analyzing, by the one or more processors, at least one of lighting, apparent color temperature, and content of the video. The processors adjust the lighting and apparent color temperature to the image such that the illusion includes the casing being located at the second location.

In some embodiments, the image provides reflections of at least a portion of the view on the rectangular casing, the frame, and the one or more muntins.

In some embodiments, a hue of the casing changes as the time-of-day at the second location changes.

In some embodiments, the one or more processors track a perspective of the user relative to the electronic display. The one or more processors modify the video based on a change in the perspective.

In some embodiments, the perspective includes a distance of the user from the electronic display and an angle at which the user is viewing the electronic display.

In some embodiments, tracking the perspective includes eye tracking or facial tracking.

In some embodiments, the one or more processors receive a signal from at least one of a camera, a sensor, or a microphone located on a shelf or a windowsill below the electronic display, the signal indicating a command from the user. The one or more processors modify the video or the image based on the command.

In some embodiments, the one or more processors provide a signal to a haptic feedback device located within the electronic display or on a shelf or a windowsill below the electronic display. The signal instructs the haptic feedback device to provide haptic feedback to the user.

In some embodiments, the image includes at least one of blinds, shades, or curtains.

In some embodiments, synchronizing the first length-of-day with the second length-of-day includes increasing or decreasing, by the one or more processors, an amount of time a portion of the video is displayed on the electronic display.

In some embodiments, the one or more processors display a backup image on the electronic display responsive to detecting an interruption in transmitting the video to the electronic display located at the second location.

In some embodiments, the one or more processors store the video on a memory of the electronic display, wherein the one or more processors are located within the electronic display.

In some embodiments, the one or more processors are located remotely to the electronic display.

In some embodiments, the one or more processors send audio signals to a speaker located proximate to the electronic display. The speaker is to play ambient sounds associated with the video.

In some embodiments, the one or more processors augment the video with a photorealistic object or animated object for displaying in the view, wherein at least one feature of the photorealistic object or animated object is modified based on the time-of-view at the first location.

In some embodiments, augmenting the video includes receiving, by the one or more processors, a clip including a portion of the video and the photorealistic object or animated object. The one or more processors insert the clip into the video at the time-of-view at the first location.

In some embodiments, a first amount of compression of the video matches a second amount of compression of the clip.

In some embodiments, the one or more processors detect that a user device of the user is connected to a wireless network, wherein the electronic display is connected to the wireless network. The one or more processors display an avatar of the user on the electronic display.

In some embodiments, synchronizing the first length-of-day with the second length-of-day includes rewinding, by the one or more processors, a portion of the video responsive to the second length-of-day being longer than the first length-of-day. The one or more processors replay the portion of the video.

In some embodiments, the one or more processors generate a foreground object for displaying on the electronic display. The foreground object is to provide the illusion of the window in the first location to the user.

Embodiments include virtual windows that simulate a view from a window as if it were at another location and/or simulate a view from a window as if it were at the same location or nearby, just unobstructed by (for instance) other buildings or architectural elements.

In some embodiments, a virtual window can match many types of existing architectural windows including any of single windows having a vertically oriented display, a panoramic window including two or more vertically oriented displays grouped in a row, either on a wall or around a corner, a panoramic window including two or more vertically oriented displays grouped in a row but with more than one row of windows, a single window having a horizontal orientation, a panoramic window including two or more horizontally oriented displays grouped in a row, either on a wall or around a corner, a panoramic window including two or more horizontally oriented displays grouped in a row but with more than one row of windows, and/or any combination of the above.

Embodiments include a skylight including one or more displays positioned either above an existing virtual window or a real window or without a window on the associated wall.

In embodiments, the content for a virtual window includes any of mastered views, views that can be downloaded to the virtual window to save bandwidth, views that can be updated and redownloaded without user intervention, and/or views that include 24-hour views of scenes captured, edited, and processed and/or delivered to one or more displays.

In embodiments, the views include any of shorter views of scenes captured, edited, and processed and delivered to one or more displays and/or synthetic (machine-created) views captured, edited and processed and delivered to one or more displays and of any duration.

In embodiments, the views can have user interface or other elements composited on top of existing views, including, but not limited to, simulations of window architectural details, messages or web-delivered information, and avatars indicating one or more users' presence at the location of the virtual window or at another virtual window.

In embodiments, all content can have sound, either captured at capture time or at editing time.

In embodiments, all content can have images and sounds composited atop existing views that arrive at user-unexpected times—so-called Unexpected Events™—which can be video or audio, or both, and which can be user-controlled, e.g., turn on, off, how often, what type of unexpected elements.

Embodiments include live views that can be captured and delivered in real time to one or more virtual windows, can have audio as with mastered content, and/or can have images and sounds composited atop existing views that arrive at user-unexpected times, as with mastered content.

Embodiments provide user control that can control which views are available to their virtual window, control which view is displayed, and/or create a playlist of views to display, including portions of views.

In embodiments, the user can exercise these controls with a mobile phone application or with a website application.

In embodiments, the user can launch the applications with a QR code displayed at appropriate times composited atop the view or adjacent to the virtual window. This could be, for instance, in a corporate environment or a hospitality environment.

In embodiments, the user can use the applications to control settings of their virtual window.

In embodiments, the user can use a physical remote to control settings of their virtual window.

In embodiments, components of a virtual window include any of the virtual window display, one or more physical displays such as, but not limited to, television displays, a virtual window player, hardware and software to display video and audio on one or more displays, and/or other elements including any of sensors, such as temperature sensors, audio devices, such as surround speakers, and/or other hardware devices.

In embodiments, the user components of the system include a virtual window server that contains metadata about users, views, and virtual windows, provides control functions for virtual windows, provides monitoring functions for virtual windows, and/or provides business logic for virtual windows.

Embodiments include a virtual window content delivery network that contains view content.

Embodiments use traditional physical window frame details, e.g., mullions, trim, etc., to make a view appear as if it is a real view.

Embodiments create simulations of traditional physical window frame details composited atop the view.

Embodiments mount the virtual window in a wall as an actual window would be installed.

Embodiments mount the virtual window on the wall to increase flexibility of window location or to reduce cost.

Embodiments include software innovations that provide for adjustment of the length of the day.

In embodiments, metadata associated with the view includes any of latitude and longitude content and/or date content was created, including daylight savings time information.

In embodiments, metadata associated with the virtual window includes any of window latitude and longitude and/or date information including daylight savings time information.

In embodiments, information about the day for a full-length view is broken down into segments, for instance, but not limited to, any of midnight to dawn, dawn to noon, noon to dusk, and/or dusk to midnight.

In embodiments, software in the system calculates times and durations that the player should skip forward to shorten a segment or skip back to lengthen a segment to match the date/time/location of the virtual window. This information is calculated for every virtual window and every day and can be managed on the server or on the player.

In embodiments, the player is responsible for skipping forward or back using a dissolve over a system-configurable number of seconds to make the skip less user-visible.

Embodiments provide Unexpected Events™. If a view has Unexpected Events™, the system determines, based on both user preferences and control and on system business logic, when these events should appear.

In embodiments, Unexpected Events™ can be any of mastered video/audio clips and/or computer-generated video/audio clips.

In embodiments, Unexpected Events™ can be downloaded ahead of use and can be added, deleted, or updated without user intervention.

Some embodiments provide the ability to watch views in the vertical orientation, then rotate the window case 90°, after which the view changes its orientation from portrait to landscape. In this embodiment, the mount that attaches the window to the wall rotates 90°. On the content side, this requires two versions of the 24-hour view content stored on the media player. The system detects which orientation the display is in and plays the correct view. For example, a computer system is configured to detect that a virtual window has rotated from the portrait orientation to a landscape orientation and display another version of a view of a location in the landscape orientation. See FIGS. 35A and 35B.

Additionally, the customer can then watch television or other programming in the landscape orientation, having the ability to enjoy the window with additional uses.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example, using italics and/or quotation marks. The use of highlighting has no influence on the scope and meaning of a term; the scope and meaning of a term are the same, in the same context, whether or not they are highlighted. It will be appreciated that the same thing can be said in more than one way. One will recognize that “memory” is one form of a “storage” and that the terms can, on occasion, be used interchangeably.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this embodiment and that various modifications can be implemented by those skilled in the art.

The terms “example,” “embodiment,” and “implementation” are used interchangeably. For example, references to “one example” or “an example” in the disclosure can be, but not necessarily are, references to the same implementation, and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the embodiment. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the examples, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the embodiment, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the embodiment should not be taken to imply that the terminology is being redefined herein to be restricted to any specific characteristics, features, or aspects of the embodiment with which that terminology is associated. In general, the terms used in the following examples should not be construed to limit the embodiment to the specific examples disclosed herein, unless the above Detailed Description explicitly defines such terms. Accordingly, the actual scope of the embodiment encompasses not only the disclosed examples but also all equivalent ways of practicing or implementing the embodiment under the examples. Some alternative implementations can include additional elements to those implementations described above or include fewer elements.

Any patents and applications and other references noted above, and any that may be listed in accompanying filing papers, are incorporated herein by reference in their entireties except for any subject matter disclaimers or disavowals and except to the extent that the incorporated material is inconsistent with the express disclosure herein, in which case the language in this disclosure controls. Aspects of the embodiment can be modified to employ the systems, functions, and concepts of the various references described above to provide yet further implementations of the embodiment.

To reduce the number of claims, certain implementations are presented below in certain forms, but the applicant contemplates various aspects of an embodiment in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A virtual window located at a first location, the virtual window comprising:
an electronic display configured to be mounted on or embedded in a surface of a building;
a layer of tempered glass spaced from the electronic display and configured to:
protect the electronic display; and
provide reflections of light visible to a user of the virtual window; and
a computer system communicably coupled to the electronic display and configured to:
store a view of a second location downloaded from a computer server,
wherein the view comprises a video filmed at the second location,
wherein the video is manipulated based on sunrise and sunset times at the first location, and
wherein downloading of the view from the computer server to the virtual window is controllable by a software application running on a user device operable by the user;
composite an image or a video clip into the video to appear within the view;
digitally add visual effects to the view, using an artificial intelligence algorithm, based on data describing weather at the first location; and
display the view on the electronic display,
wherein adding the visual effects to the view and displaying the view on the electronic display are controllable by the software application.

2. The virtual window of claim 1, wherein the computer system is configured to:
display a quick-response (QR) code within the view,
wherein the QR code is configured to:
blend into a background of the first view, and
display a universal resource locator (URL) on the user device,
wherein a web page associated with the URL is configured to enable a selection, by the user, of a second view for displaying on the virtual window.

3. The virtual window of claim 1, wherein the computer system is configured to:
display a background color on the virtual window for writing on the tempered glass using a marker,
wherein the background color contrasts with a color of the marker.

4. The virtual window of claim 1, wherein the image or the video clip is downloaded from the computer server and represents a photorealistic object or animated object.

5. The virtual window of claim 1, wherein the view of the second location is selectable by the user using the software application.

6. The virtual window of claim 1, wherein the computer system is configured to adjust a hue of the view based on a particular time at the first location.

7. The virtual window of claim 1, wherein the computer system is configured to:
track a perspective of the user relative to the virtual window; and
adjust the view based on a change in the perspective.

8. The virtual window of claim 1, wherein the view is displayed in a portrait orientation, and
wherein the computer system is configured to:
detect that the virtual window has rotated from the portrait orientation to a landscape orientation; and
display another version of the view of the second location in the landscape orientation.

9. The virtual window of claim 1, wherein the video is filmed using a digital movie camera having a camera angle corresponding to a horizon at the second location.

10. The virtual window of claim 9, wherein a lens of the digital movie camera has a focal length corresponding to a field of view of a human eye, and
wherein the video comprises audio recorded at the second location.

11. The virtual window of claim 1, wherein the view is selectable on the user device from among a library of views downloaded to the virtual window.

12. The virtual window of claim 1, wherein the virtual window is recessed into a wall,
wherein the virtual window comprises a rectangular frame comprising one or more magnets embedded in the frame, and
wherein the frame is configured to be removably mounted to the wall around the electronic display using the one or more magnets.

13. The virtual window of claim 1, wherein the computer system is configured to:
turn off the electronic display when it is nighttime at the first location.

14. A virtual window system comprising:
at least one hardware processor; and
at least one non-transitory memory storing instructions, which, when executed by the at least one hardware processor, cause the virtual window system to:
transmit a first view, selected by a user, to a first virtual window at a particular location for displaying the first view on the first virtual window,
wherein an object, having a first perspective corresponding to the first view, moves across the first view;
generate a second view, corresponding to the first view, in accordance with an orientation of a second virtual window at the particular location for displaying the second view on the second virtual window,
wherein the object moves across the second view before or after it moves across the first view, and
wherein the object has a second perspective in the second view based on a spatial relationship between the second virtual window and the first virtual window; and
transmit the second view to the second virtual window for displaying on the second virtual window.

15. The virtual window system of claim 14, wherein the instructions cause the virtual window system to:
manipulate the first view and the second view to match a sunrise and sunset time at the particular location.

16. At least one non-transitory, computer-readable storage medium storing instructions, which, when executed by at least one data processor of a computer system, cause the computer system to:
determine that a menu option in a software application executing on the computer system has been set to display an avatar of a user of a virtual window within views displayed on the virtual window when the user is present at a particular location;
receive input selecting a view for displaying on the virtual window;
responsive to receiving the input:
cause the virtual window to display the view on an electronic display of the virtual window;
determine that the computer system is connected to a wireless network associated with the particular location; and
responsive to determining that the computer system is connected to the wireless network:
cause the virtual window to display the avatar within the view on the electronic display.

17. The at least one non-transitory, computer-readable storage medium of claim 16, wherein the avatar is generated by a computer server,
wherein the avatar changes as images within the view change, and
wherein the instructions cause the computer system to cause the virtual window to:
download the avatar from the computer server, and
composite the avatar into the view.

18. The at least one non-transitory, computer-readable storage medium of claim 17, wherein downloading video from the computer server by the virtual window is performed using a video codec to reduce greenhouse gas emissions caused by the downloading.

19. The at least one non-transitory, computer-readable storage medium of claim 16, wherein the instructions cause the computer system to:
receive second input selecting multiple views depicting multiple geographical locations filmed at a particular time; and
cause display of the multiple views on the virtual window in a sequence.

20. The at least one non-transitory, computer-readable storage medium of claim 16, wherein the instructions cause the computer system to:
retrieve live weather data; and
cause digital addition of visual effects, generated by an artificial intelligence algorithm, to the view based on the live weather data.
